(19) United States
(12) Patent Application Publication
(10) Pub. No.: US 2025/0384596 A1
(43) Pub. Date: Dec. 18, 2025

(54) INTERACTION INITIATION BY A VIRTUAL ASSISTANT

(71) Applicant: Meta Platforms Technologies, LLC, Menlo Park, CA (US)

(72) Inventors: Frances Cin-Yee Lai, York (CA); Rorik Henrikson, Toronto (CA)

(21) Appl. No.: 19/280,060

(22) Filed: Jul. 24, 2025

Related U.S. Application Data
(63) Continuation of application No. 18/064,714, filed on Dec. 12, 2022.
(60) Provisional application No. 63/362,098, filed on Mar. 29, 2022.

(51) Int. Cl. G06T 11/00; G06F 3/01; G06F 9/451; G06N 5/025

(52) U.S. Cl. CPC G06T 11/00; G06F 9/453; G06N 5/025; G06F 3/011; G06F 3/017; G06T 2200/24

(57) ABSTRACT

Techniques are for analyzing contextual clues from an extended reality environment and, based on the analysis of the contextual clues, intuitively superimposing and integrating customized digital information into the artificial reality environment via a virtual assistant to recommend and lead the user into suggested action. A method includes obtaining input data from a user, generating a graph of objects, attributes, and relationships between objects extracted from the input data, determining one or more interactions to be presented, initiated, or executed based on the graph and a profile associated with the user, determining virtual content data to be used for rendering virtual content based on the one or more interactions, and rendering the virtual content in an extended reality environment displayed to the user based on the virtual content data. The virtual content is used to present, initiate, or execute the one or more interactions for the user.

### CROSS-REFERENCE TO RELATED APPLICATIONS

This application is a continuation of U.S. application Ser. No. 18/064,714, filed Dec. 12, 2022, entitled “Interaction Initiation By A Virtual Assistant,” which claims priority to U.S. Provisional Application No. 63/362,098, filed Mar. 29, 2022, entitled “Interaction Initiation By A Virtual Assistant,” each of which is hereby incorporated by reference in its entirety.

### FIELD

The present disclosure relates generally to virtual assistants in an extended reality environment, and more particularly, to techniques for analyzing contextual clues from an extended reality environment and, based on the analysis of the contextual clues, intuitively superimposing and integrating customized digital information into the artificial reality environment via a virtual assistant to recommend and lead the user into suggested actions.

### BACKGROUND

A virtual assistant is an artificial intelligence (AI) enabled software agent that can perform tasks or services including: answer questions, provide information, play media, and provide an intuitive interface for connected devices such as smart home devices, for an individual based on voice or text utterances (e.g., commands or questions). Conventional virtual assistants process the words a user speaks or types and converts them into digital data that the software can analyze. The software uses a speech and/or text recognition-algorithm to find the most likely answer, solution to a problem, information, or command for a given task. As the number of utterances increase, the software learns over time what users want when they provide various utterances. This helps improve the reliability and speed of responses and services. In addition to their self-learning ability, their customizable features and scalability have lead virtual assistants to gain popularity across various domain spaces including website chat, computing devices such as smart phones and automobiles, and as standalone passive listening devices.

Even though virtual assistants have proven to be a powerful tool, these domain spaces have proven to be an inappropriate venue for such a tool. The virtual assistant will continue to be an integral part in these domain spaces but will always likely be viewed as a complementary feature or limited use case, but not a crucial must have feature. Which is why more recently, developers have been looking for a better suited domain space for deploying virtual assistants. That domain space is extended reality. Extended reality is a form of reality that has been adjusted in some manner before presentation to a user, which may include, e.g., a virtual reality (VR), an augmented reality (AR), a mixed reality (MR), a hybrid reality, or some combination and/or derivatives thereof. Extended reality content may include completely generated virtual content or generated virtual content combined with physical content (e.g., physical or real-world objects). The extended reality content may include digital images or animation, video, audio, haptic feedback, or some combination thereof, and any of which may be presented in a single channel or in multiple channels (such as stereo video that produces a three-dimensional effect to the viewer). Extended reality may be associated with applications, products, accessories, services, or some combination thereof, that are, e.g., used to create content in an extended reality and/or used in (e.g., perform activities in) an extended reality. The extended reality system that provides such content may be implemented on various platforms, including a head-mounted display (HMD) connected to a host computer system, a standalone HMD, a mobile device or computing system, or any other hardware platform capable of providing extended reality content to one or more viewers.

However, extended reality headsets and devices are limited in the way users interact with applications. Some provide hand controllers, but controllers betray the point of freeing the user's hands and limit the use of extended reality headsets. Others have developed sophisticated hand gestures for interacting with the components of extended reality applications. Hand gestures are a good medium, but they have their limits. For example, given the limited field of view that extended reality headsets have, hand gestures require users to keep their arms extended so that they enter the active area of the headset's sensors. This can cause fatigue and again limit the use of the headset. This is why virtual assistants have become important as a new interface for extended reality devices such as headsets. Virtual assistants can easily blend in with all the other features that the extended reality devices provide to their users. Virtual assistants can help users accomplish tasks with their extended reality devices that previously required controller input or hand gestures on or in view of the extended reality devices. Users can use virtual assistants to open and close applications, activate features, or interact with virtual objects. When combined with other technologies such as eye tracking, virtual assistants can become even more useful. For instance, users can query for information about the object they're staring at, or ask the virtual assistant to revolve, move, or manipulate a virtual object without using gestures.

### BRIEF SUMMARY

Techniques disclosed herein relate generally to virtual assistants in an extended reality environment. More specifically and without limitation, techniques disclosed herein relate to analyzing information and contextual clues from an extended reality environment and based on the analysis, intuitively superimposing and integrating customized digital information into the artificial reality environment via a virtual assistant to recommend and lead the user into suggested action. The information and contextual clues analyzed for providing the interaction may include various inputs such as eye-tracking, user gestures, environmental sensor input, or input obtainable from remote devices. The extended reality system superimposes and integrates the interactions as customized digital information (e.g., glimmers and glyphs) into the extended reality environment in order to present, initiate, and/or execute the interaction with the user.

In various embodiments, a computer-implemented method is provided that includes: obtaining input data from a user, wherein the input data comprises: (i) data regarding activity of the user in an extended reality environment, (ii) data from external systems, or (iii) both, generating a graph of objects, attributes, and relationships between objects extracted from the input data, determining one or more interactions to be presented, initiated, or executed based on the graph and a profile associated with the user, determining virtual content data to be used for rendering virtual content based on the one or more interactions, and rendering the virtual content in the extended reality environment displayed to the user based on the virtual content data, wherein the virtual content is used to present, initiate, or execute the one or more interactions for the user.

In some embodiments, the profile comprises a plurality of goals and associated action spaces, the action spaces are defined and encoded as sub-hierarchical structures comprised of interactions, tasks, and workflows, the interactions are defined using sets of rules, decisions trees, or vectors, the rules, decisions trees, or vectors connect context to the action spaces and enable a virtual assistant to determine the one or more interactions should be presented, initiated, or executed, the context comprises circumstances that form a setting for the activity of the user in the physical environment, the virtual environment, or the combination thereof, and the action spaces further comprise virtual content data defined and coded for the action spaces in order to assist the user with achieving one or more of the plurality of goals.

In some embodiments, the determining the one or more interactions to be presented, initiated, or executed, comprises: (i) inputting values of the graph into the rules or decisions trees to determine the one or more interactions, or (ii) embedding the context graph into a context vector and comparing the context vector to the vectors to determine the one or more interactions.

In some embodiments, the computer-implemented method further includes: obtaining new input data from the user, wherein the new input data comprises: (i) new data regarding activity of the user in the extended reality environment, (ii) new data from the external systems, or (iii) both, identifying a request by the user for a user interface to interact with a virtual assistant based on the new input data, in response to the request by the user for the user interface, rendering the user interface in the extended reality environment displayed to the user, receiving interface input from the user interacting with the user interface, determining one or more modifications to be made to the one or more interactions based on the interface input, determining new virtual content data to be used for rendering new virtual content based on the one or more modifications, and rendering the new virtual content in the extended reality environment displayed to the user based on the new virtual content data, wherein the virtual content is used to present, initiate, or execute the one or more interactions for the user with the one or more modifications.

In some embodiments, the computer-implemented method further includes determining learned behavior of the user associated with the one or more interactions using rule-based artificial intelligence, machine learning based artificial intelligence, or both, wherein the virtual content data is determined based on the one or more interactions and the learned behavior.

In some embodiments, the determining the learned behavior of the user comprises: collecting historical input data from the user, wherein the historical input data comprises: (i) historical data regarding activity of the user in the extended reality environment, (ii) historical data from the external systems, or (iii) both, retraining or fine-tuning rule based systems, algorithms, models, or a combination thereof for implementing the rule-based artificial intelligence, the machine learning based artificial intelligence, or both, and determining the learned behavior of the user associated with the one or more interactions using the retrained or fine-tuned rule based systems, algorithms, models, or a combination thereof.

In some embodiments, the computer-implemented method further includes linking the learned behavior with active spaces, workflows, or tasks for the one or more interactions.

In various embodiments, an extended reality system is provided that includes: a head-mounted device comprising a display to display content to a user and one or more sensors to capture input data; one or more processors; and one or more memories accessible to the one or more processors, the one or more memories storing a plurality of instructions executable by the one or more processors, the plurality of instructions comprising instructions that when executed by the one or more processors cause the one or more processors to perform processing comprising: obtaining the input data from the user, wherein the input data comprises: (i) data regarding activity of the user in an extended reality environment, (ii) data from external systems, or (iii) both; generating a graph of objects, attributes, and relationships between objects extracted from the input data; determining one or more interactions to be presented, initiated, or executed based on the graph and a profile associated with the user; determining virtual content data to be used for rendering virtual content based on the one or more interactions; and rendering the virtual content in the extended reality environment displayed to the user based on the virtual content data, wherein the virtual content is used to present, initiate, or execute the one or more interactions for the user.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a network environment in accordance with various embodiments.

FIG. 2A an illustration depicting an example extended reality system that presents and controls user interface elements within an extended reality environment in accordance with various embodiments.

FIG. 2B an illustration depicting user interface elements in accordance with various embodiments.

FIG. 3A is an illustration of an augmented reality system in accordance with various embodiments.

FIG. 3B is an illustration of a virtual reality system in accordance with various embodiments.

FIG. 4A is an illustration of haptic devices in accordance with various embodiments.

FIG. 4B is an illustration of an exemplary virtual reality environment in accordance with various embodiments.

FIG. 4C is an illustration of an exemplary augmented reality environment in accordance with various embodiments.

FIG. 5A is a simplified block diagram of a virtual assistant in accordance with various embodiments.

FIG. 5B is an illustration of defined and encoded long term goals in accordance with various embodiments.

FIG. 6 is a flowchart illustrating a process for presenting, initiating, and/or executing an interaction with a user in accordance with various embodiments.

FIGS. 7A, 7B, and 7C are an illustration of presenting, initiating, and executing interactions in an extended reality environment in accordance with various embodiments.

FIG. 8 is a flowchart illustrating a process for making a modification to an interaction proposed by the virtual assistant in accordance with various embodiments.

FIGS. 9A, 9B, and 9C are an illustration of making a modification to an interaction proposed by the virtual assistant in an extended reality environment in accordance with various embodiments.

FIGS. 10A, 10B, and 10C are an illustration of making an alternative modification to an interaction proposed by the virtual assistant in an extended reality environment in accordance with various embodiments.

FIG. 11 is a flowchart illustrating a process for presenting, initiating, and/or executing an interaction with learned behavior cues in accordance with various embodiments.

FIGS. 12A, 12B, and 12C are an illustration of presenting, initiating, and/or executing an interaction with learned behavior in an extended reality environment in accordance with various embodiments.

FIGS. 13A-13B are an illustration of presenting, initiating, and/or executing an interaction with learned behavior in an extended reality environment in accordance with various embodiments.

FIGS. 14A, 14B, 14C, 14D and 14E are an illustration of presenting, initiating, and/or executing an interaction with learned behavior and making a modification to the interaction in an extended reality environment in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Extended reality systems are becoming increasingly ubiquitous with applications in many fields such as computer gaming, health and safety, industrial, and education. As a few examples, extended reality systems are being incorporated into mobile devices, gaming consoles, personal computers, movie theaters, and theme parks. Typical extended reality systems include one or more devices for rendering and displaying content to users. As one example, an extended reality system may incorporate a HMD worn by a user and configured to output extended reality content to the user. The extended reality content may be generated in a wholly or partially simulated environment that people sense and/or interact with via an electronic system. The simulated environment may be a VR environment, which is designed to be based entirely on computer-generated sensory inputs (e.g., virtual content) for one or more user senses, or a MR environment, which is designed to incorporate sensory inputs (e.g., a view of the physical surroundings) from the physical environment, or a representation thereof, in addition to including computer-generated sensory inputs (e.g., virtual content). Examples of MR include AR and augmented virtuality (AV). An AR environment is a simulated environment in which one or more virtual objects are superimposed over a physical environment, or a representation thereof, or a simulated environment in which a representation of a physical environment is transformed by computer-generated sensory information. An AV environment refers to a simulated environment in which a virtual or computer-generated environment incorporates one or more sensory inputs from the physical environment. In any instance—VR. MR, AR, or AV, during operation, the user typically interacts with the extended reality system to interact with extended reality content.

Fundamentally extended reality, especially AR/AV, are media technologies that aim to present virtual content in the most natural form possible, e.g., by integrating simulated sights, sounds, and even feelings into our perception of the real world around us. This means AR/AV, more than any form of media to date, has the potential to alter our sense of reality, distorting how we interpret our direct daily experiences. In an augmented world, simply walking into your residence can become a wild amalgamation of the physical and the virtual. Our surroundings may become filled with persons, places, objects, and activities that don't actually exist. However, if an extended reality system provides too much virtual content to a user, for example in terms of the number and frequency of information being displayed, that virtual content can become overwhelming to the user. In order to address this challenge and others, the present disclosure analyzes contextual clues from an extended reality environment and, based on the analysis of the contextual clues, intuitively superimposes and integrates customized virtual content into the extended reality environment via a virtual assistant.

In an exemplary embodiment, a computer-implemented method is provided that includes obtaining input data from a user, where the input data comprises: (i) data regarding activity of the user in an extended reality environment, (ii) data from external systems, or (iii) both; generating a graph of objects, attributes, and relationships between objects extracted from the input data; determining one or more interactions to be presented, initiated, or executed based on the graph and a profile associated with the user; determining virtual content data to be used for rendering virtual content based on the one or more interactions; and rendering the virtual content in the extended reality environment displayed to the user based on the virtual content data. The virtual content is used to present, initiate, or execute the one or more interactions for the user.

### Extended Reality System Overview

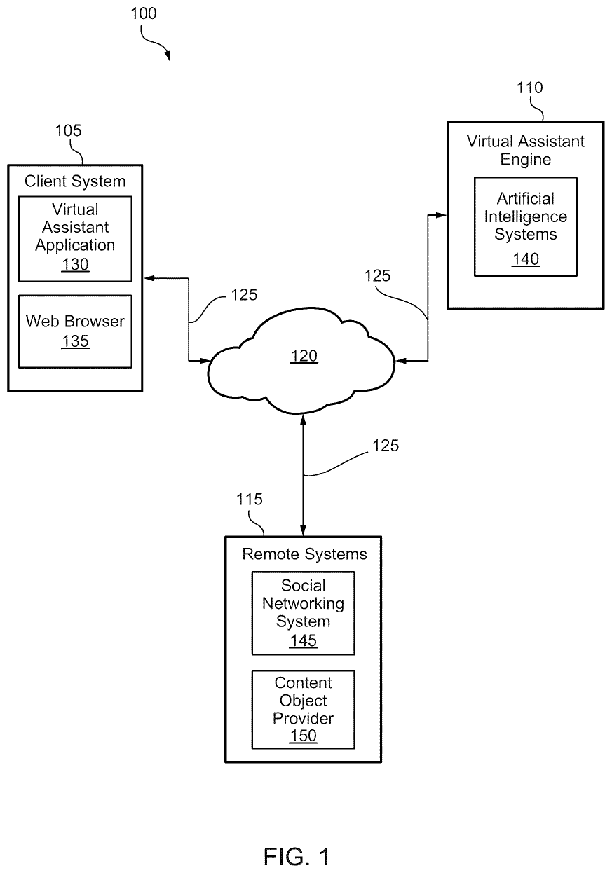

FIG. 1 illustrates an example network environment 100 associated with an extended reality system in accordance with aspects of the present disclosure. Network environment 100 includes a client system 105, a virtual assistant engine 110, and remote systems 115 connected to each other by a network 120. Although FIG. 1 illustrates a particular arrangement of a client system 105, a virtual assistant engine 110, remote systems 115, and a network 120, this disclosure contemplates any suitable arrangement of a client system 105, a virtual assistant engine 110, remote systems 115, and a network 120. As an example and not by way of limitation, two or more of a client system 105, a virtual assistant engine 110, and remote systems 115 may be connected to each other directly, bypassing network 120. As another example, two or more of a client system 105, a virtual assistant engine 110, and remote systems 115 may be physically or logically co-located with each other in whole or in part. Moreover, although FIG. 1 illustrates a particular number of a client system 105, a virtual assistant engine 110, remote systems 115, and networks 120, this disclosure contemplates any suitable number of client systems 105, virtual assistant engines 110, remote systems 115, and networks 120. As an example and not by way of limitation, network environment 100 may include multiple client systems 105, virtual assistant engines 110, remote systems 115, and networks 115.

This disclosure contemplates any suitable network 120. As an example and not by way of limitation, one or more portions of a network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 120 may include one or more networks 120.

Links 125 may connect a client system 105, a virtual assistant engine 110, and a remote systems 115 to a communication network 110 or to each other. This disclosure contemplates any suitable links 125. In particular embodiments, one or more links 125 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 125 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 125, or a combination of two or more such links 125. Links 125 need not necessarily be the same throughout a network environment 100. One or more first links 125 may differ in one or more respects from one or more second links 125.

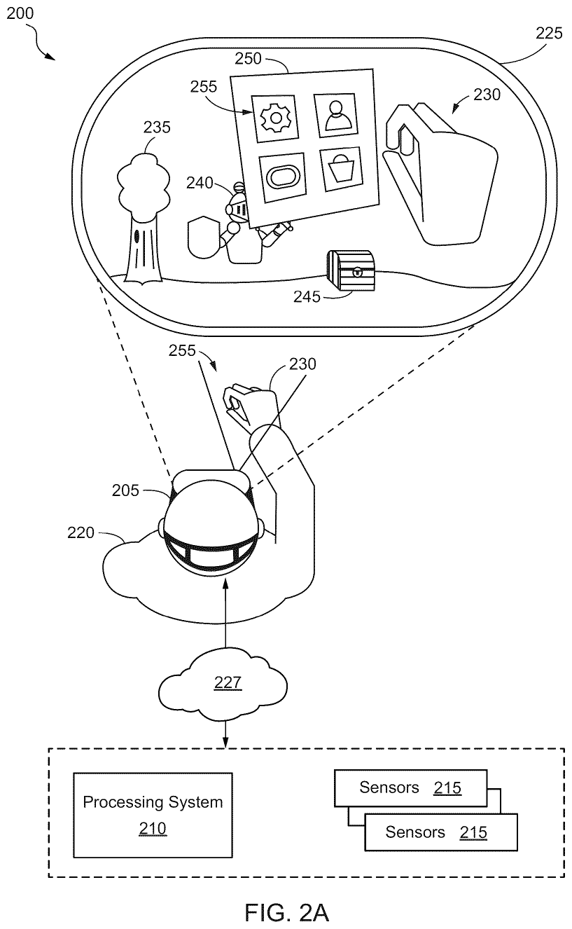

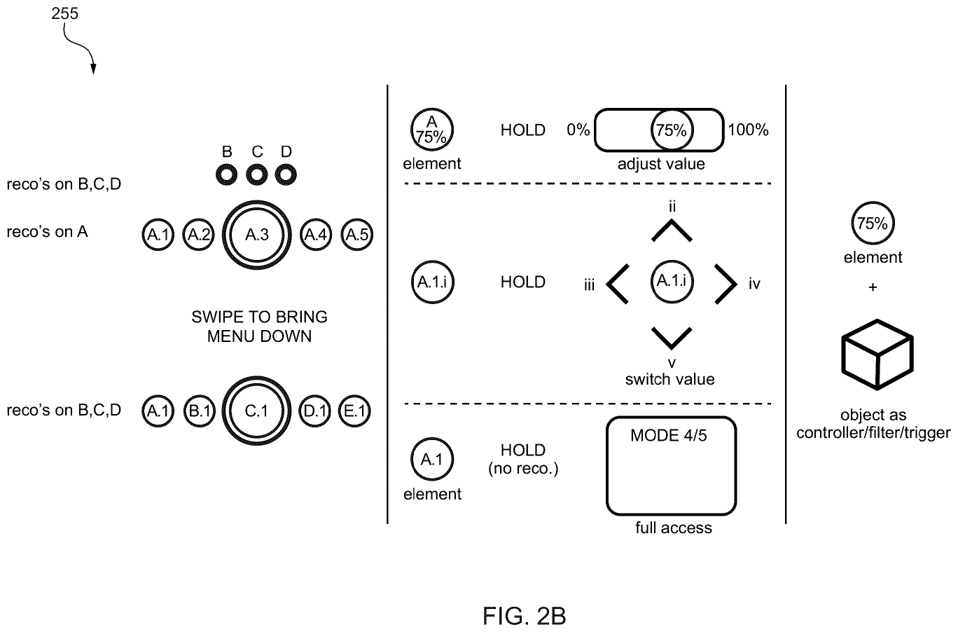

In various embodiments, a client system 105 is an electronic device including hardware, software, or embedded logic components or a combination of two or more such components and capable of carrying out the appropriate extended reality functionalities in accordance with techniques of the disclosure. As an example, and not by way of limitation, a client system 105 may include a desktop computer, notebook or laptop computer, netbook, a tablet computer, e-book reader, GPS device, camera, personal digital assistant (PDA), handheld electronic device, cellular telephone, smartphone, a VR. MR, AR, or VR headset such as an AR/VR HMD, other suitable electronic devices capable of displaying extended reality content, or any suitable combination thereof. In particular embodiments, the client system 105 is an AR/VR HMD as described in detail with respect to FIG. 2. This disclosure contemplates any suitable client system 105 configured to generate and output extended reality content to the user. The client system 105 may enable its user to communicate with other users at other client systems 105.

In various embodiments, the client system 105 includes a virtual assistant application 130. The virtual assistant application 130 instantiates at least a portion of the virtual assistant, which can provide information or services to a user based on a combination of user input, contextual awareness (such as clues from the physical environment or clues from user behavior), and the capability to access information from a variety of online sources (such as weather conditions, traffic information, news, stock prices, user schedules, retail prices, etc.). The user input may include text (e.g., online chat), especially in an instant messaging application or other applications, voice, eye-tracking, user motion such as gestures or running, or a combination of them. The virtual assistant may perform concierge-type services (e.g., making dinner reservations, purchasing event tickets, making travel arrangements, and the like), provide information (e.g., reminders, information concerning an object in an environment, information concerning a task or interaction, answers to questions, training regarding a task or activity, and the like), goal assisted services (e.g., generating and implementing an exercise regimen to achieve a certain level of fitness or weight loss, implementing electronic devices such as lights, heating, ventilation, and air conditioning systems, coffee maker, television, etc. generate and execute a morning routine such as wake up, get ready for work, make breakfast, and travel to work, and the like), or combinations thereof. The virtual assistant may also perform management or data-handling tasks based on online information and events without user initiation or interaction. Examples of those tasks that may be performed by a virtual assistant may include schedule management (e.g., sending an alert to a dinner date that a user is running late due to traffic conditions, update schedules for both parties, and change the restaurant reservation time). The virtual assistant may be enabled in an extended reality environment by a combination of the client system 105, the virtual assistant engine 110, application programming interfaces (APIs), and the proliferation of applications on user devices such as the remote systems 115.

A user at the client system 105 may use the virtual assistant application 130 to interact with the virtual assistant engine 110. In some instances, the virtual assistant application 130 is a stand-alone application or integrated into another application such as a social-networking application or another suitable application (e.g., an artificial simulation application). In some instances, the virtual assistant application 130 is integrated into the client system 105 (e.g., part of the operating system of the client system 105), an assistant hardware device, or any other suitable hardware devices. In some instances, the virtual assistant application 130 may be accessed via a web browser 135. In some instances, the virtual assistant application 130 passively listens to and watches interactions of the user in the real-world, and processes what it hears and sees (e.g., explicit input such as audio commands or interface commands, contextual awareness derived from audio or physical actions of the user, objects in the real-world, environmental triggers such as weather or time, and the like) in order to interact with the user in an intuitive manner.

In particular embodiments, the virtual assistant application 130 receives or obtains input from a user, the physical environment, a virtual reality environment, or a combination thereof via different modalities. As an example, and not by way of limitation, the modalities may include audio, text, image, video, motion, graphical or virtual user interfaces, orientation, sensors, etc. The virtual assistant application 130 communicates the input to the virtual assistant engine 110. Based on the input, the virtual assistant engine 110 analyzes the input and generates responses (e.g., text or audio responses, device commands such as a signal to turn on a television, virtual content such as a virtual object, or the like) as output. The virtual assistant engine 110 may send the generated responses to the virtual assistant application 130, the client system 105, the remote systems 115, or a combination thereof. The virtual assistant application 130 may present the response to the user at the client system 130 (e.g., rendering virtual content overlaid on a real-world object within the display). The presented responses may be based on different modalities such as audio, text, image, and video. As an example, and not by way of limitation, context concerning activity of a user in the physical world may be analyzed and determined to initiate an interaction for completing an immediate task or goal, which may include the virtual assistant application 130 retrieving traffic information (e.g., via a remote system 115). The virtual assistant application 130 may communicate the request for traffic information to virtual assistant engine 110. The virtual assistant engine 110 may accordingly contact a remote system 115 and retrieve traffic information as a result of the request and send the traffic information back to the virtual assistant application 110. The virtual assistant application 110 may then present the traffic information to the user as text (e.g., as virtual content overlaid on the physical environment such as real-world object) or audio (e.g., spoken to the user in natural language through a speaker associated with the client system 105).

In various embodiments, the virtual assistant engine 110 assists users to retrieve information from various sources, request services from different service providers, assist users to learn or complete goals and tasks using various sources and/or service providers, and combinations thereof. In some instances, the virtual assistant engine 110 receives input data from the virtual assistant application 130 and determines one or more interactions based on the input data that could be executed to request information, services, and/or complete a goal or task of the user. The interactions are actions that could be presented to a user for execution in an extended reality environment. In some instances, the interactions are influenced by other actions associated with the user. The interactions are aligned with goals or tasks associated with the user. The goals may comprise, for example, long term goals such as be fit, intermediate goals such as complete weekly exercise challenge, and immediate goals such as complete today's exercise regimen. Each goal may be associated with a workflow of actions or tasks for achieving the goal. For example for today's exercise regimen, the workflow of actions or tasks may comprise possible classes or programs for completing today's exercise regimen, the individual exercises to be performed for the classes or programs, the repetition, sets, and/or time associated with performing each exercise, and any equipment need for each of the exercises.

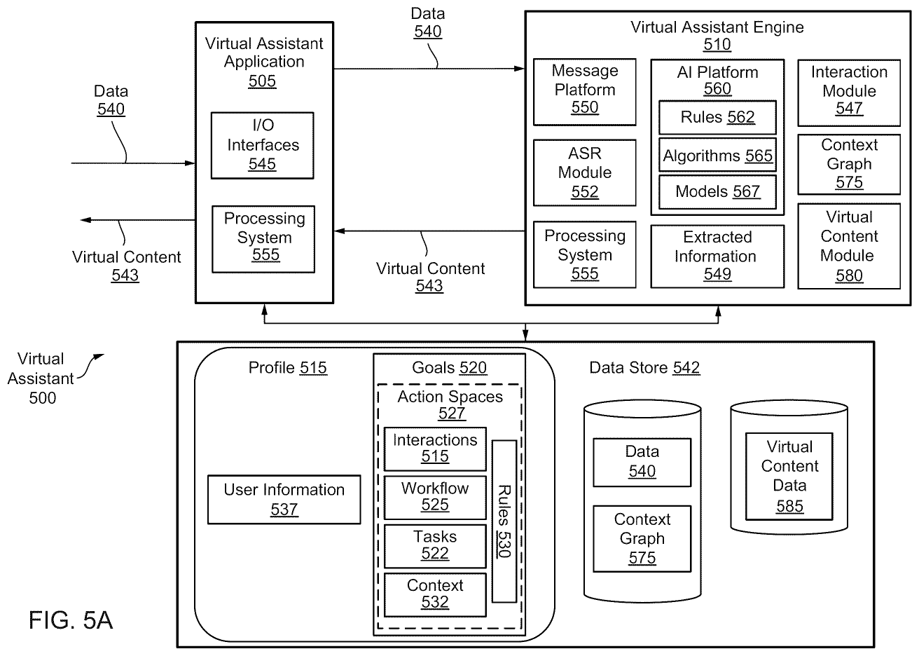

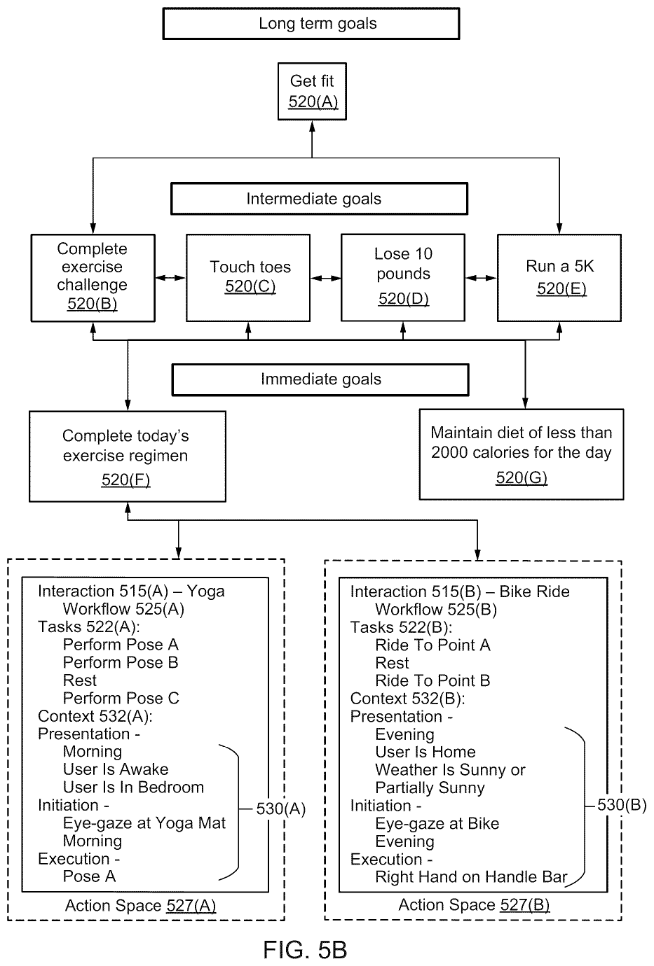

The virtual assistant engine 110 may use artificial intelligence systems 140 (e.g., rule based systems or machine-learning based systems such as natural-language understanding models) to analyze the input based on a user's profile and other relevant information. The result of the analysis may comprise different interactions associated with a task or goal of the user. The virtual assistant 110 may then retrieve information, request services, and/or generate instructions, recommendations, or virtual content associated with one or more of the different interactions for completing tasks or goals. In some instances, the virtual assistant engine 110 interacts with a remote system 115 such as a social-networking system 145 when retrieving information, requesting service, and/or generating instructions or recommendations for the user. The virtual assistant engine 110 may generate virtual content for the user using various techniques such as natural-language generating, virtual object rendering, and the like. The virtual content may comprise, for example, the retrieved information, the status of the requested services, a virtual object such as a glimmer overlaid on a physical object such as a bicycle, light, or yoga mat, a modeled pose for an exercise, and the like. In particular embodiments, the virtual assistant engine 110 enables the user to interact with it regarding the information, services, or goals using a graphical or virtual interface, a stateful and multi-turn conversation using dialog-management techniques, and/or a stateful and multi-action interaction using task-management techniques. The functionality of the virtual assistant engine 110 is described in more detail with respect to FIGS. 5A and 5B.

In various embodiments, a remote system 115 may include one or more types of servers, one or more data stores, one or more interfaces, including but not limited to APIs, one or more web services, one or more content sources, one or more networks, or any other suitable components, e.g., that servers may communicate with. A remote system 115 may be operated by a same entity or a different entity from an entity operating the virtual assistant engine 110. In particular embodiments, however, the virtual assistant engine 110 and third-party systems 115 may operate in conjunction with each other to provide virtual content to users of the client system 105. For example, a social-networking system 145 may provide a platform, or backbone, which other systems, such as third-party systems, may use to provide social-networking services and functionality to users across the Internet, and the virtual assistant engine 110 may access these systems to provide virtual content on the client system 105.

In particular embodiments, the social-networking system 145 may be a network-addressable computing system that can host an online social network. The social-networking system 145 may generate, store, receive, and send social-networking data, such as, for example, user-profile data, concept-profile data, social-graph information, or other suitable data related to the online social network. The social-networking system 145 may be accessed by the other components of network environment 100 either directly or via a network 120. As an example and not by way of limitation, a client system 105 may access the social-networking system 145 using a web browser 135, or a native application associated with the social-networking system 145 (e.g., a mobile social-networking application, a messaging application, another suitable application, or any combination thereof) either directly or via a network 120. The social-networking system 145 may provide users with the ability to take actions on various types of items or objects, supported by the social-networking system 145. As an example and not by way of limitation, the items and objects may include groups or social networks to which users of the social-networking system 145 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 145 or by an external system of the remote systems 115, which is separate from the social-networking system 145 and coupled to the social-networking system 115 via the network 120.

The remote system 115 may include a content object provider 150. A content object provider 150 includes one or more sources of virtual content objects, which may be communicated to the client system 105. As an example and not by way of limitation, virtual content objects may include information regarding things or activities of interest to the user, such as, for example, movie show times, movie reviews, restaurant reviews, restaurant menus, product information and reviews, instructions on how to perform various tasks, exercise regimens, cooking recipes, or other suitable information. As another example and not by way of limitation, content objects may include incentive content objects, such as coupons, discount tickets, gift certificates, or other suitable incentive objects. As another example and not by way of limitation, content objects may include virtual objects such as virtual interfaces, 2D or 3D graphics, media content, or other suitable virtual objects.

FIG. 2A illustrates an example client system 200 (e.g., client system 105 described with respect to FIG. 1) in accordance with aspects of the present disclosure. Client system 200 includes an extended reality system 205 (e.g., a HMD), a processing system 210, and one or more sensors 215. As shown, extended reality system 205 is typically worn by user 220 and comprises an electronic display (e.g., a transparent, translucent, or solid display), optional controllers, and optical assembly for presenting extended reality content 225 to the user 220. The one or more sensors 215 may include motion sensors (e.g., accelerometers) for tracking motion of the extended reality system 205 and may include one or more image capture devices (e.g., cameras, line scanners) for capturing image data of the surrounding physical environment. In this example, processing system 210 is shown as a single computing device, such as a gaming console, workstation, a desktop computer, or a laptop. In other examples, processing system 210 may be distributed across a plurality of computing devices, such as a distributed computing network, a data center, or a cloud computing system. In other examples, processing system 210 may be integrated with the HMD 205. extended reality system 205, the processing system 210, and the one or more sensors 215 are communicatively coupled via a network 227, which may be a wired or wireless network, such as Wi-Fi, a mesh network, or a short-range wireless communication medium such as Bluetooth wireless technology, or a combination thereof. Although extended reality system 205 is shown in this example as in communication with, e.g., tethered to or in wireless communication with, processing system 210, in some implementations extended reality system 205 operates as a stand-alone, mobile extended reality system.

In general, client system 200 uses information captured from a real-world, physical environment to render extended reality content 225 for display to the user 220. In the example of FIG. 2, the user 220 views the extended reality content 225 constructed and rendered by an extended reality application executing on processing system 210 and/or extended reality system 205. In some examples, the extended reality content 225 viewed through the extended reality system 205 comprises a mixture of real-world imagery (e.g., the user's hand 230 and physical objects 235) and virtual imagery (e.g., virtual content such as information or objects 240, 245 and virtual user interface 250) to produce mixed reality and/or augmented reality. In some examples, virtual information or objects 240, 245 may be mapped (e.g., pinned, locked, placed) to a particular position within extended reality content 225. For example, a position for virtual information or objects 240, 245 may be fixed, as relative to one of walls of a residence or surface of the earth, for instance. A position for virtual information or objects 240, 245 may be variable, as relative to a physical object 235 or the user 220, for instance. In some examples, the particular position of virtual information or objects 240, 245 within the extended reality content 225 is associated with a position within the real world, physical environment (e.g., on a surface of a physical object 235).

In the example shown in FIG. 2A, virtual information or objects 240, 245 are mapped at a position relative to a physical object 235. As should be understood, the virtual imagery (e.g., virtual content such as information or objects 240, 245 and virtual user interface 250) does not exist in the real-world, physical environment. Virtual user interface 250 may be fixed, as relative to the user 220, the user's hand 230, physical objects 235, or other virtual content such as virtual information or objects 240, 245, for instance. As a result, client system 200 renders, at a user interface position that is locked relative to a position of the user 220, the user's hand 230, physical objects 235, or other virtual content in the extended reality environment, virtual user interface 250 for display at extended reality system 205 as part of extended reality content 225. As used herein, a virtual element ‘locked’ to a position of virtual content or physical object is rendered at a position relative to the position of the virtual content or physical object so as to appear to be part of or otherwise tied in the extended reality environment to the virtual content or physical object.

In some implementations, the client system 200 generates and renders virtual content (e.g., GIFs, photos, applications, live-streams, videos, text, a web-browser, drawings, animations, representations of data files, or any other visible media) on a virtual surface. A virtual surface may be associated with a planar or other real-world surface (e.g., the virtual surface corresponds to and is locked to a physical surface, such as a wall table, or ceiling). In the example shown in FIG. 2A, the virtual surface is associated with the sky and ground of the physical environment. In other examples, a virtual surface can be associated with a portion of a surface (e.g., a portion of the wall). In some examples, only the virtual content items contained within a virtual surface are rendered. In other examples, the virtual surface is generated and rendered (e.g., as a virtual plane or as a border corresponding to the virtual surface). In some examples, a virtual surface can be rendered as floating in a virtual or real-world physical environment (e.g., not associated with a particular real-world surface). The client system 200 may render one or more virtual content items in response to a determination that at least a portion of the location of virtual content items is in a field of view of the user 220. For example, client system 200 may render virtual user interface 250 only if a given physical object (e.g., a lamp) is within the field of view of the user 220.

During operation, the extended reality application constructs extended reality content 225 for display to user 220 by tracking and computing interaction information (e.g., yoga pose information) for a frame of reference, typically a viewing perspective of extended reality system 205. Using extended reality system 205 as a frame of reference, and based on a current field of view as determined by a current estimated interaction of extended reality system 205, the extended reality application renders extended reality content 225 which, in some examples, may be overlaid, at least in part, upon the real-world, physical environment of the user 220. During this process, the extended reality application uses sensed data received from extended reality system 205 and sensors 215, such as movement information, contextual awareness, and/or user commands, and, in some examples, data from any external sensors, such as third-party information or device, to capture information within the real world, physical environment, such as motion by user 220 and/or feature tracking information with respect to user 220. Based on the sensed data, the extended reality application determines interaction information to be presented for the frame of reference of extended reality system 205 and, in accordance with the current context of the user 220, renders the extended reality content 225.

Client system 205 may trigger generation and rendering of virtual content based on a current field of view of user 220, as may be determined by real-time gaze 255 tracking of the user, or other conditions. More specifically, image capture devices of the sensors 215 capture image data representative of objects in the real world, physical environment that are within a field of view of image capture devices. During operation, the client system 200 performs object recognition within image data captured by the image capture devices of extended reality system 205 to identify objects in the physical environment such as the user 220, the user's hand 230, and/or physical objects 235. Further, the client system 200 tracks the position, orientation, and configuration of the objects in the physical environment over a sliding window of time. Field of view typically corresponds with the viewing perspective of the extended reality system 205. In some examples, the extended reality application presents extended reality content 225 comprising mixed reality and/or augmented reality.

As illustrated in FIG. 2A, the extended reality application may render virtual content, such as virtual information or objects 240, 245 on a transparent display such that the virtual content is overlaid on real-world objects, such as the portions of the user 220, the user's hand 230, physical objects 235, that are within a field of view of the user 220. In other examples, the extended reality application may render images of real-world objects, such as the portions of the user 220, the user's hand 230, physical objects 235, that are within field of view along with virtual objects, such as virtual information or objects 240, 245 within extended reality content 225. In other examples, the extended reality application may render virtual representations of the portions of the user 220, the user's hand 230, physical objects 235 that are within field of view (e.g., render real-world objects as virtual objects) within extended reality content 225. In either example, user 220 is able to view the portions of the user 220, the user's hand 230, physical objects 235 and/or any other real-world objects or virtual content that are within field of view within extended reality content 225. In other examples, the extended reality application may not render representations of the user 220 and the user's hand 230; and instead only render the physical objects 235 and/or virtual information or objects 240, 245.

In various embodiments, the client system 200 renders to extended reality system 205 extended reality content 225 in which virtual user interface 250 is locked relative to a position of the user 220, the user's hand 230, physical objects 235, or other virtual content in the extended reality environment. That is, the client system 205 may render a virtual user interface 250 having one or more virtual user interface elements at a position and orientation that is based on and corresponds to the position and orientation of the user 220, the user's hand 230, physical objects 235, or other virtual content in the extended reality environment. For example, if a physical object is positioned in a vertical position on a table, the client system 205 may render the virtual user interface 250 at a location corresponding to the position and orientation of the physical object in the extended reality environment. Alternatively, if the user's hand 230 is within the field of view, the client system 200 may render the virtual user interface at a location corresponding to the position and orientation of the user's hand 230 in the extended reality environment. Alternatively, if other virtual content is within the field of view, the client system 200 may render the virtual user interface at a location corresponding to a general predetermined position of the field of view (e.g., a bottom of the field of view) in the extended reality environment. Alternatively, if other virtual content is within the field of view, the client system 200 may render the virtual user interface at a location corresponding to the position and orientation of the other virtual content in the extended reality environment. In this way, the virtual user interface 250 being rendered in the virtual environment may track the user 220, the user's hand 230, physical objects 235, or other virtual content such that the user interface appears, to the user, to be associated with the user 220, the user's hand 230, physical objects 235, or other virtual content in the extended reality environment.

As shown in FIG. 2B, virtual user interface 250 includes one or more virtual user interface elements 255. Virtual user interface elements 255 may include, for instance, a virtual drawing interface, a selectable menu (e.g., a drop-down menu), virtual buttons, a virtual slider or scroll bar, a directional pad, a keyboard, or other user-selectable user interface elements, glyphs, display elements, content, user interface controls, and so forth. The particular virtual user interface elements 255 for virtual user interface 250 may be context-driven based on the current extended reality applications engaged by the user 220 or real-world actions/tasks being performed by the user 220. When a user performs a user interface gesture in the extended reality environment at a location that corresponds to one of the virtual user interface elements 255 of virtual user interface 250, the client system 200 detects the gesture relative to the virtual user interface elements 255 and performs an action associated with the gesture and the virtual user interface elements 255. For example, the user 220 may press their finger at a button element 255 location on the virtual user interface 250. The button element 255 and/or virtual user interface 250 location may or may not be overlaid on the user 220, the user's hand 230, physical objects 235, or other virtual content, e.g., correspond to a position in the physical environment such as on a light switch or controller at which the client system 200 renders the virtual user interface button. In this example, the client system 200 detects this virtual button press gesture and performs an action corresponding to the detected press of a virtual user interface button (e.g., turns the light on). The client system 205 may also, for instance, animate a press of the virtual user interface button along with the button press gesture.

The client system 200 may detect user interface gestures and other gestures using an inside-out or outside-in tracking system of image capture devices and or external cameras. The client system 200 may alternatively, or in addition, detect user interface gestures and other gestures using a presence-sensitive surface. That is, a presence-sensitive interface of the extended reality system 205 and/or controller may receive user inputs that make up a user interface gesture. The extended reality system 205 and/or controller may provide haptic feedback to touch-based user interaction by having a physical surface with which the user can interact (e.g., touch, drag a finger across, grab, and so forth). In addition, peripheral extended reality system 205 and/or controller may output other indications of user interaction using an output device. For example, in response to a detected press of a virtual user interface button, extended reality system 205 and/or controller may output a vibration or “click” noise, or extended reality system 205 and/or controller may generate and output content to a display. In some examples, the user 220 may press and drag their finger along physical locations on the extended reality system 205 and/or controller corresponding to positions in the virtual environment at which the client system 205 renders virtual user interface elements 255 of virtual user interface 250. In this example, the client system 205 detects this gesture and performs an action according to the detected press and drag of virtual user interface elements 255, such as by moving a slider bar in the virtual environment. In this way, client system 200 simulates movement of virtual content using virtual user interface elements 255 and gestures.

Various embodiments disclosed herein may include or be implemented in conjunction with various types of extended reality systems. Extended reality content generated by the extended reality systems may include completely computer-generated content or computer-generated content combined with captured (e.g., real-world) content. The extended reality content may include video, audio, haptic feedback, or some combination thereof, any of which may be presented in a single channel or in multiple channels (such as stereo video that produces a three-dimensional (3D) effect to the viewer). Additionally, in some embodiments, extended reality may also be associated with applications, products, accessories, services, or some combination thereof, that are used to, for example, create content in an extended reality and/or are otherwise used in (e.g., to perform activities in) an extended reality.

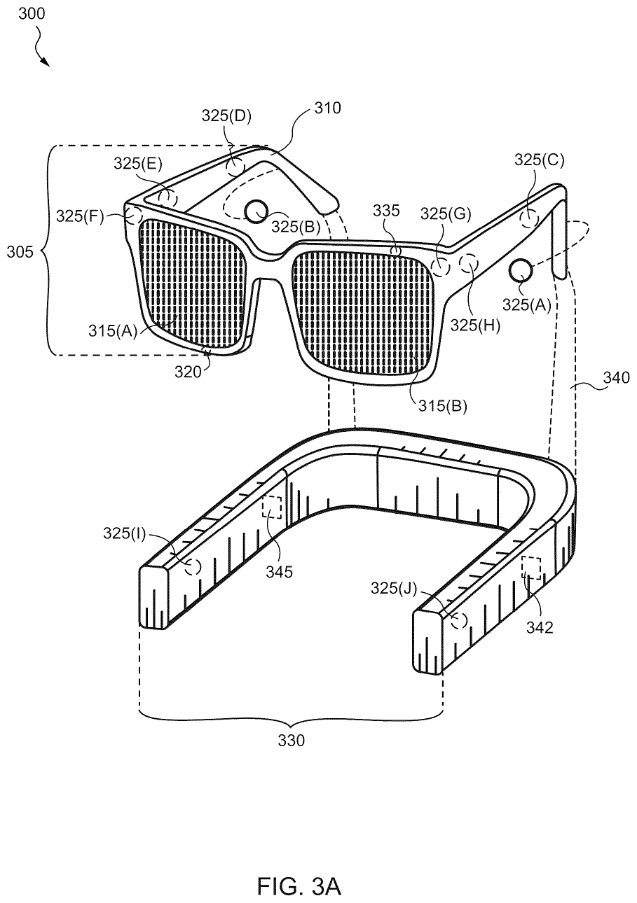

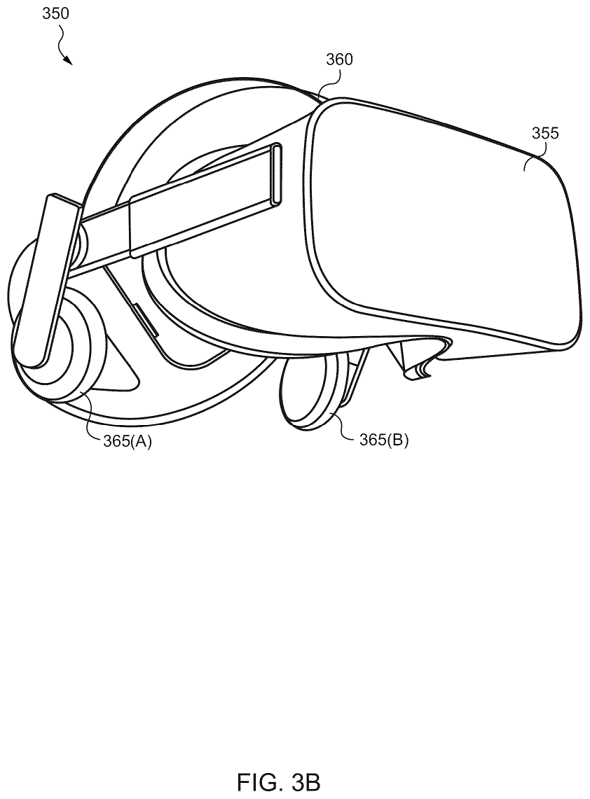

The extended reality systems may be implemented in a variety of different form factors and configurations. Some extended reality systems may be designed to work without near-eye displays (NEDs). Other extended reality systems may include an NED that also provides visibility into the real world (such as, e.g., augmented reality system 300 in FIG. 3A) or that visually immerses a user in an extended reality (such as, e.g., virtual reality system 350 in FIG. 3B). While some extended reality devices may be self-contained systems, other extended reality devices may communicate and/or coordinate with external devices to provide an extended reality experience to a user. Examples of such external devices include handheld controllers, mobile devices, desktop computers, devices worn by a user, devices worn by one or more other users, and/or any other suitable external system.

As shown in FIG. 3A, augmented reality system 300 may include an eyewear device 305 with a frame 310 configured to hold a left display device 315(A) and a right display device 315(B) in front of a user's eyes. Display devices 315(A) and 315(B) may act together or independently to present an image or series of images to a user. While augmented reality system 300 includes two displays, embodiments of this disclosure may be implemented in augmented reality systems with a single NED or more than two NEDs.

In some embodiments, augmented reality system 300 may include one or more sensors, such as sensor 320. Sensor 320 may generate measurement signals in response to motion of augmented reality system 300 and may be located on substantially any portion of frame 310. Sensor 320 may represent one or more of a variety of different sensing mechanisms, such as a position sensor, an inertial measurement unit (IMU), a depth camera assembly, a structured light emitter and/or detector, or any combination thereof. In some embodiments, augmented reality system 300 may or may not include sensor 320 or may include more than one sensor. In embodiments in which sensor 320 includes an IMU, the IMU may generate calibration data based on measurement signals from sensor 320. Examples of sensor 320 may include, without limitation, accelerometers, gyroscopes, magnetometers, other suitable types of sensors that detect motion, sensors used for error correction of the IMU, or some combination thereof.

In some examples, augmented reality system 300 may also include a microphone array with a plurality of acoustic transducers 325(A)-325(J), referred to collectively as acoustic transducers 325. Acoustic transducers 325 may represent transducers that detect air pressure variations induced by sound waves. Each acoustic transducer 325 may be configured to detect sound and convert the detected sound into an electronic format (e.g., an analog or digital format). The microphone array in FIG. 3A may include, for example, ten acoustic transducers: 325(A) and 325(B), which may be designed to be placed inside a corresponding ear of the user, acoustic transducers 325(C), 325(D), 325(E), 325(F), 325(G), and 325(H), which may be positioned at various locations on frame 310, and/or acoustic transducers 325(I) and 325(J), which may be positioned on a corresponding neckband 330.

In some embodiments, one or more of acoustic transducers 325(A)-(J) may be used as output transducers (e.g., speakers). For example, acoustic transducers 325(A) and/or 325(B) may be earbuds or any other suitable type of headphone or speaker. The configuration of acoustic transducers 325 of the microphone array may vary. While augmented reality system 300 is shown in FIG. 3 as having ten acoustic transducers 325, the number of acoustic transducers 325 may be greater or less than ten. In some embodiments, using higher numbers of acoustic transducers 325 may increase the amount of audio information collected and/or the sensitivity and accuracy of the audio information. In contrast, using a lower number of acoustic transducers 325 may decrease the computing power required by an associated controller 335 to process the collected audio information. In addition, the position of each acoustic transducer 325 of the microphone array may vary. For example, the position of an acoustic transducer 325 may include a defined position on the user, a defined coordinate on frame 310, an orientation associated with each acoustic transducer 325, or some combination thereof.

Acoustic transducers 325(A) and 325(B) may be positioned on different parts of the user's ear, such as behind the pinna, behind the tragus, and/or within the auricle or fossa. Or, there may be additional acoustic transducers 325 on or surrounding the ear in addition to acoustic transducers 325 inside the ear canal. Having an acoustic transducer 325 positioned next to an ear canal of a user may enable the microphone array to collect information on how sounds arrive at the ear canal. By positioning at least two of acoustic transducers 325 on either side of a user's head (e.g., as binaural microphones), augmented reality device 300 may simulate binaural hearing and capture a 3D stereo sound field around about a user's head. In some embodiments, acoustic transducers 325(A) and 325(B) may be connected to augmented reality system 300 via a wired connection 340, and in other embodiments acoustic transducers 325(A) and 325(B) may be connected to augmented reality system 300 via a wireless connection (e.g., a Bluetooth connection). In still other embodiments, acoustic transducers 325(A) and 325(B) may not be used at all in conjunction with augmented reality system 300.

Acoustic transducers 325 on frame 310 may be positioned in a variety of different ways, including along the length of the temples, across the bridge, above or below display devices 315(A) and 315(B), or some combination thereof. Acoustic transducers 325 may also be oriented such that the microphone array is able to detect sounds in a wide range of directions surrounding the user wearing the augmented reality system 300. In some embodiments, an optimization process may be performed during manufacturing of augmented reality system 300 to determine relative positioning of each acoustic transducer 325 in the microphone array.

In some examples, augmented reality system 300 may include or be connected to an external device (e.g., a paired device), such as neckband 330. Neckband 330 generally represents any type or form of paired device. Thus, the following discussion of neckband 330 may also apply to various other paired devices, such as charging cases, smart watches, smart phones, wrist bands, other wearable devices, hand-held controllers, tablet computers, laptop computers, other external compute devices, etc.

As shown, neckband 330 may be coupled to eyewear device 305 via one or more connectors. The connectors may be wired or wireless and may include electrical and/or non-electrical (e.g., structural) components. In some cases, eyewear device 305 and neckband 330 may operate independently without any wired or wireless connection between them. While FIG. 3A illustrates the components of eyewear device 305 and neckband 330 in example locations on eyewear device 305 and neckband 330, the components may be located elsewhere and/or distributed differently on eyewear device 305 and/or neckband 330. In some embodiments, the components of eyewear device 305 and neckband 330 may be located on one or more additional peripheral devices paired with eyewear device 305, neckband 330, or some combination thereof.

Pairing external devices, such as neckband 330, with augmented reality eyewear devices may enable the eyewear devices to achieve the form factor of a pair of glasses while still providing sufficient battery and computation power for expanded capabilities. Some or all of the battery power, computational resources, and/or additional features of augmented reality system 300 may be provided by a paired device or shared between a paired device and an eyewear device, thus reducing the weight, heat profile, and form factor of the eyewear device overall while still retaining desired functionality. For example, neckband 330 may allow components that would otherwise be included on an eyewear device to be included in neckband 330 since users may tolerate a heavier weight load on their shoulders than they would tolerate on their heads. Neckband 330 may also have a larger surface area over which to diffuse and disperse heat to the ambient environment. Thus, neckband 330 may allow for greater battery and computation capacity than might otherwise have been possible on a stand-alone eyewear device. Since weight carried in neckband 330 may be less invasive to a user than weight carried in eyewear device 305, a user may tolerate wearing a lighter eyewear device and carrying or wearing the paired device for greater lengths of time than a user would tolerate wearing a heavy standalone eyewear device, thereby enabling users to more fully incorporate extended reality environments into their day-to-day activities.

Neckband 330 may be communicatively coupled with eyewear device 305 and/or to other devices. These other devices may provide certain functions (e.g., tracking, localizing, depth mapping, processing, storage, etc.) to augmented reality system 300. In the embodiment of FIG. 3A, neckband 330 may include two acoustic transducers (e.g., 325(I) and 325(J)) that are part of the microphone array (or potentially form their own microphone subarray). Neckband 330 may also include a controller 342 and a power source 345.

Acoustic transducers 325(I) and 325(J) of neckband 330 may be configured to detect sound and convert the detected sound into an electronic format (analog or digital). In the embodiment of FIG. 3A, acoustic transducers 325(I) and 325(J) may be positioned on neckband 330, thereby increasing the distance between the neckband acoustic transducers 325(I) and 325(J) and other acoustic transducers 325 positioned on eyewear device 305. In some cases, increasing the distance between acoustic transducers 325 of the microphone array may improve the accuracy of beamforming performed via the microphone array. For example, if a sound is detected by acoustic transducers 325(C) and 325(D) and the distance between acoustic transducers 325(C) and 325(D) is greater than, e.g., the distance between acoustic transducers 325(D) and 325(E), the determined source location of the detected sound may be more accurate than if the sound had been detected by acoustic transducers 325(D) and 325(E).

Controller 342 of neckband 330 may process information generated by the sensors on neckband 330 and/or augmented reality system 300. For example, controller 342 may process information from the microphone array that describes sounds detected by the microphone array. For each detected sound, controller 342 may perform a direction-of-arrival (DOA) estimation to estimate a direction from which the detected sound arrived at the microphone array. As the microphone array detects sounds, controller 342 may populate an audio data set with the information. In embodiments in which augmented reality system 300 includes an inertial measurement unit, controller 342 may compute all inertial and spatial calculations from the IMU located on eyewear device 305. A connector may convey information between augmented reality system 300 and neckband 330 and between augmented reality system 300 and controller 342. The information may be in the form of optical data, electrical data, wireless data, or any other transmittable data form. Moving the processing of information generated by augmented reality system 300 to neckband 330 may reduce weight and heat in eyewear device 305, making it more comfortable to the user.

Power source 345 in neckband 330 may provide power to eyewear device 305 and/or to neckband 330. Power source 345 may include, without limitation, lithium ion batteries, lithium-polymer batteries, primary lithium batteries, alkaline batteries, or any other form of power storage. In some cases, power source 345 may be a wired power source. Including power source 345 on neckband 330 instead of on eyewear device 305 may help better distribute the weight and heat generated by power source 345.

As noted, some extended reality systems may, instead of blending an extended reality with actual reality, substantially replace one or more of a user's sensory perceptions of the real world with a virtual experience. One example of this type of system is a head-worn display system, such as virtual reality system 350 in FIG. 3B, that mostly or completely covers a user's field of view. Virtual reality system 350 may include a front rigid body 355 and a band 360 shaped to fit around a user's head. Virtual reality system 1700 may also include output audio transducers 365(A) and 365(B). Furthermore, while not shown in FIG. 3B, front rigid body 355 may include one or more electronic elements, including one or more electronic displays, one or more inertial measurement units (IMUs), one or more tracking emitters or detectors, and/or any other suitable device or system for creating an extended reality experience.

Extended reality systems may include a variety of types of visual feedback mechanisms. For example, display devices in augmented reality system 300 and/or virtual reality system 350 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These extended reality systems may include a single display screen for both eyes or may provide a display screen for each eye, which may allow for additional flexibility for varifocal adjustments or for correcting a user's refractive error. Some of these extended reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the extended reality systems described herein may include one or more projection systems. For example, display devices in augmented reality system 300 and/or virtual reality system 350 may include micro-LED projectors that project light (using, e.g., a waveguide) into display devices, such as clear combiner lenses that allow ambient light to pass through. The display devices may refract the projected light toward a user's pupil and may enable a user to simultaneously view both extended reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Extended reality systems may also be configured with any other suitable type or form of image projection system, such as retinal projectors used in virtual retina displays.

The extended reality systems described herein may also include various types of computer vision components and subsystems. For example, augmented reality system 300 and/or virtual reality system 350 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An extended reality system may process data from one or more of these sensors to identify a location of a user, to map the real world, to provide a user with context about real-world surroundings, and/or to perform a variety of other functions.

The extended reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the extended reality systems described herein may also include tactile (e.g., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other extended reality devices, within other extended reality devices, and/or in conjunction with other extended reality devices.

By providing haptic sensations, audible content, and/or visual content, extended reality systems may create an entire virtual experience or enhance a user's real-world experience in a variety of contexts and environments. For instance, extended reality systems may assist or extend a user's perception, memory, or cognition within a particular environment. Some systems may enhance a user's interactions with other people in the real world or may enable more immersive interactions with other people in a virtual world. Extended reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's extended reality experience in one or more of these contexts and environments and/or in other contexts and environments.

As noted, extended reality systems 300 and 350 may be used with a variety of other types of devices to provide a more compelling extended reality experience. These devices may be haptic interfaces with transducers that provide haptic feedback and/or that collect haptic information about a user's interaction with an environment. The extended reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

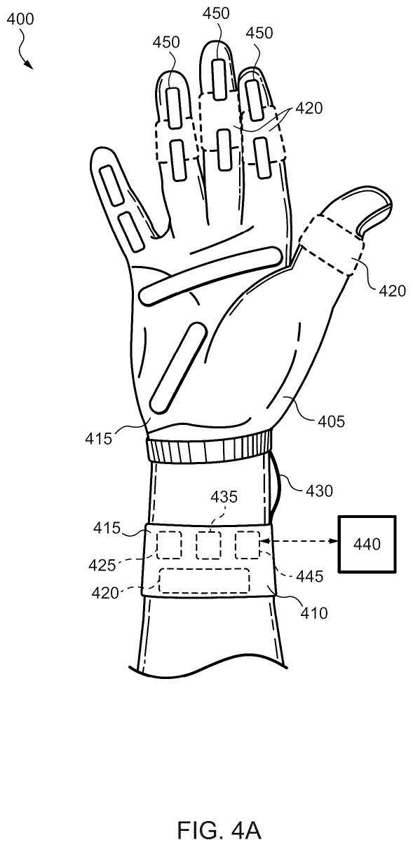

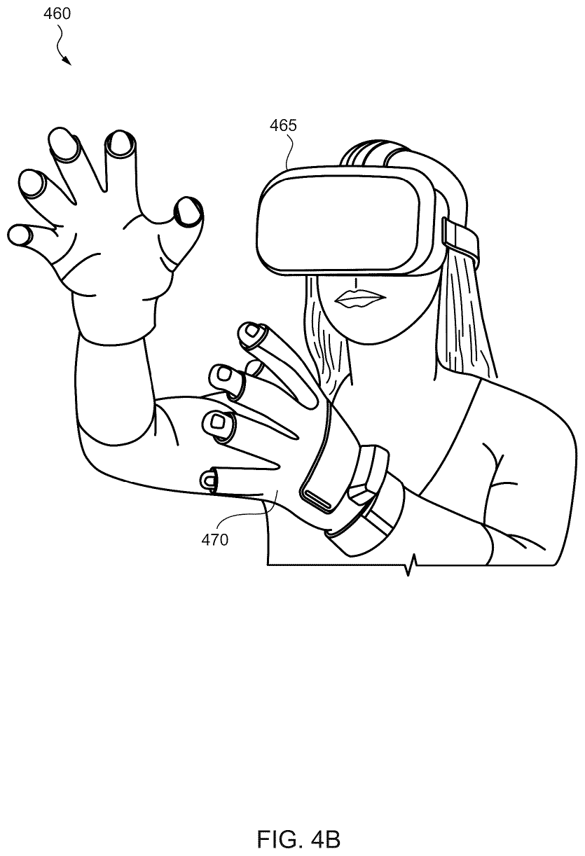

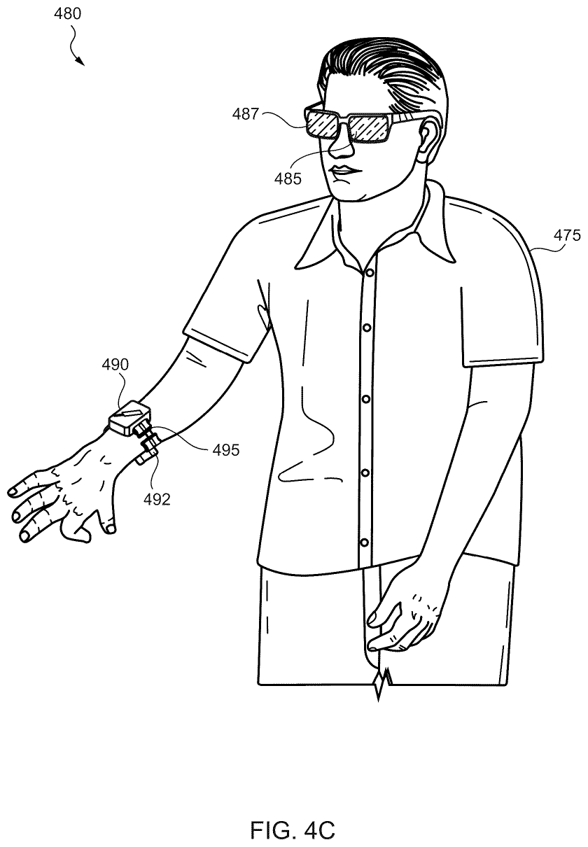

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 4A illustrates a vibrotactile system 400 in the form of a wearable glove (haptic device 405) and wristband (haptic device 410). Haptic device 405 and haptic device 410 are shown as examples of wearable devices that include a flexible, wearable textile material 415 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 420 may be positioned at least partially within one or more corresponding pockets formed in textile material 415 of vibrotactile system 400. Vibrotactile devices 420 may be positioned in locations to provide a vibrating sensation (e.g., haptic feedback) to a user of vibrotactile system 400. For example, vibrotactile devices 420 may be positioned against the user's finger(s), thumb, or wrist, as shown in FIG. 4A. Vibrotactile devices 420 may, in some examples, be sufficiently flexible to conform to or bend with the user's corresponding body part(s).

A power source 425 (e.g., a battery) for applying a voltage to the vibrotactile devices 420 for activation thereof may be electrically coupled to vibrotactile devices 420, such as via conductive wiring 430. In some examples, each of vibrotactile devices 420 may be independently electrically coupled to power source 425 for individual activation. In some embodiments, a processor 435 may be operatively coupled to power source 425 and configured (e.g., programmed) to control activation of vibrotactile devices 420.

Vibrotactile system 400 may be implemented in a variety of ways. In some examples, vibrotactile system 400 may be a standalone system with integral subsystems and components for operation independent of other devices and systems. As another example, vibrotactile system 400 may be configured for interaction with another device or system 440. For example, vibrotactile system 400 may, in some examples, include a communications interface 445 for receiving and/or sending signals to the other device or system 440. The other device or system 440 may be a mobile device, a gaming console, an extended reality (e.g., virtual reality, augmented reality, mixed-reality) device, a personal computer, a tablet computer, a network device (e.g., a modem, a router, etc.), a handheld controller, etc. Communications interface 445 may enable communications between vibrotactile system 400 and the other device or system 440 via a wireless (e.g., Wi-Fi, Bluetooth, cellular, radio, etc.) link or a wired link. If present, communications interface 445 may be in communication with processor 435, such as to provide a signal to processor 435 to activate or deactivate one or more of the vibrotactile devices 420.

Vibrotactile system 400 may optionally include other subsystems and components, such as touch-sensitive pads 450, pressure sensors, motion sensors, position sensors, lighting elements, and/or user interface elements (e.g., an on/off button, a vibration control element, etc.). During use, vibrotactile devices 420 may be configured to be activated for a variety of different reasons, such as in response to the user's interaction with user interface elements, a signal from the motion or position sensors, a signal from the touch-sensitive pads 450, a signal from the pressure sensors, a signal from the other device or system 440, etc.

Although power source 425, processor 435, and communications interface 445 are illustrated in FIG. 4A as being positioned in haptic device 410, the present disclosure is not so limited. For example, one or more of power source 425, processor 435, or communications interface 445 may be positioned within haptic device 405 or within another wearable textile.

Haptic wearables, such as those shown in and described in connection with FIG. 4A, may be implemented in a variety of types of extended reality systems and environments. FIG. 4B shows an example extended reality environment 460 including one head-mounted virtual reality display and two haptic devices (e.g., gloves), and in other embodiments any number and/or combination of these components and other components may be included in an extended reality system. For example, in some embodiments there may be multiple head-mounted displays each having an associated haptic device, with each head-mounted display and each haptic device communicating with the same console, portable computing device, or other computing system.

HMD 465 generally represents any type or form of virtual reality system, such as virtual reality system 350 in FIG. 3B. Haptic device 470 generally represents any type or form of wearable device, worn by a user of an extended reality system, that provides haptic feedback to the user to give the user the perception that he or she is physically engaging with a virtual object. In some embodiments, haptic device 470 may provide haptic feedback by applying vibration, motion, and/or force to the user. For example, haptic device 470 may limit or augment a user's movement. To give a specific example, haptic device 470 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 470 to send action requests to a console. Examples of action requests include, without limitation, requests to start an application and/or end the application and/or requests to perform a particular action within the application.

While haptic interfaces may be used with virtual reality systems, as shown in FIG. 4B, haptic interfaces may also be used with augmented reality systems, as shown in FIG. 4C. FIG. 4C is a perspective view of a user 475 interacting with an augmented reality system 480. In this example, user 475 may wear a pair of augmented reality glasses 485 that may have one or more displays 487 and that are paired with a haptic device 490. In this example, haptic device 490 may be a wristband that includes a plurality of band elements 492 and a tensioning mechanism 495 that connects band elements 492 to one another.

One or more of band elements 492 may include any type or form of actuator suitable for providing haptic feedback. For example, one or more of band elements 492 may be configured to provide one or more of various types of cutaneous feedback, including vibration, force, traction, texture, and/or temperature. To provide such feedback, band elements 492 may include one or more of various types of actuators. In one example, each of band elements 492 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 405, 410, 470, and 490 may include any suitable number and/or type of haptic transducer, sensor, and/or feedback mechanism. For example, haptic devices 405, 410, 470, and 490 may include one or more mechanical transducers, piezoelectric transducers, and/or fluidic transducers. Haptic devices 405, 410, 470, and 490 may also include various combinations of different types and forms of transducers that work together or independently to enhance a user's extended reality experience. In one example, each of band elements 492 of haptic device 490 may include a vibrotactor (e.g., a vibrotactile actuator) configured to vibrate in unison or independently to provide one or more of various types of haptic sensations to a user.

FIG. 5A illustrates an example architecture of a virtual assistant 500. In various embodiments, the virtual assistant 500 is an engineered entity residing in software, hardware, or a combination thereof that interfaces with users in a human way. The virtual assistant 500 incorporates elements of interactive responses (e.g., voice or text) and context awareness to assist, e.g., deliver information and services, users via one or more interactions. The virtual assistant 500 is instantiated using a virtual assistant application 505 (e.g., virtual assistant application 130 as described with respect to FIG. 1) on the client system and a virtual assistant engine 510 (e.g., virtual assistant engine 110 as described with respect to FIG. 1) on the client system, a separate computing system remote from the client system, or a combination thereof. The virtual assistant application 505 and the virtual assistant engine 510 assist users to retrieve information from different sources, request services from different service providers, assist users to learn or complete goals and tasks using different sources and/or service providers, and combinations thereof. In particular embodiments, the virtual assistant engine 510 receives input data from the virtual assistant application 505 and determines one or more interactions 515 based on the input data that could be executed to request information or services, and/or complete a goal 520 or task 522 of the user. The interactions 515 are actions that could be presented to a user. In some instances, the interaction 515 are influenced by other actions associated with the user. The interactions 515 are aligned with goals 520 or tasks 522 associated with the user. Each goal 520 may be associated with a workflow 525 of actions or tasks 522 to be completed for achieving the goal 520.

In various embodiments, the goals 520, tasks 522, and workflows 525 are defined and encoded by a developer and included as part of the virtual assistant. Encoding is the process of putting a sequence of characters (letters, numbers, punctuation, and certain symbols) into a specialized format for efficient transmission or storage. For example, a developer may define and encode the goals 520 as a hierarchical structure comprised of long-term goals, intermediate goals, and immediate goals and the relationships thereof. The developer may further define and encode action spaces 527 for achieving the goals 520. The action spaces 527 may be defined and encoded as sub-hierarchical structures comprised of interactions 515, tasks 522, and workflows 525. The interactions 515 may be further defined using sets of rules, decisions trees, or vectors 530. The rules, decisions trees, or vectors 530 connect context 532 to the action spaces 527 and enable the virtual assistant engine to determine whether a given interaction should be presented to a user and/or initiated based on the context 532. The context 532 comprises, for example, the circumstances that form the setting for an event, action, or task, and in terms of which it can be understood and assessed (e.g., a group of conditions that exist where and when something happens such as an event, action, or task—[context(1)]: whenever it rains and the outside temperature is less than 70 degrees, [action]: the user puts on their rain coat, [context(2)]: prior to going outside). Thus, context (1) and (2) could be used to generate rules, a decision tree, or vector to connect the context (1) and (2) to an action space associated with an interaction for recommending that the user put on their raincoat before going outside.

FIG. 5B illustrates an example of defined and encoded long term goals 520 (A) for helping a user to get fit. The long-term goals 520 (A) may be broken down into various intermediate goals 520 (B-E) and immediate goals 520 (F-G) in a hierarchical structure. The action spaces 527 (A-B) may be encoded for the immediate goal 520 (F). As shown, the encoding of the action space 527 (A) may comprise assigning an interaction 515 (A), a workflow 525 (A) associated with the interaction 515 (A), and tasks 522(A) associated with the workflow 525 (A). The encoding of the action space 527 (A) may further comprise assigning rules, decisions trees, or vectors 530 (A) to the interaction 515 (A), which connects context 532 (A) to the action space 527 (A). The encoding of the action space 527 (B) may comprise assigning an interaction 515 B), a workflow 525 (B) associated with the interaction 515 (B), and tasks 522(B) associated with the workflow 525 (B). The encoding of the action space 527 (B) may further comprise assigning rules, decisions trees, or vectors 530 (B) to the interaction 515 (B), which connects context 532 (B) to the action space 527 (B). As should be understood, immediate goal 520 (G) may be defined and encoded in a similar manner using action spaces 527. Further, it should be understood that goals at any level (not just the immediate goal level) may be defined and encoded as illustrated with respect to immediate goal 520 (F).

The virtual assistant engine 510 is configured to create and store a user profile 515 comprising information associated with the user. More specifically, the profile 515 includes the goals 520, action spaces 527, and user information 537. The goals 520 may comprise, for example, long term goals such as be fit, intermediate goals such as complete weekly exercise challenge, and immediate goals such as complete today's exercise regimen. The action spaces 527 may comprise, for example, interactions 515, workflows 525, associated with the interactions 515, tasks 522 associated with the workflows 525, sets of rules, decisions trees, or vectors 530 associated with the interactions 515, and the connected context 532 thereof. The user information 527 may comprise, for example, user preferences, identification information, health information, financial information, education, skill sets, contacts, social networking feeds, and the like.

The goals 520, action spaces 527, and user information 537 may be associated with the user profile 515 by direct user input. For example, the user may select various goals 520 that they are interested in achieving from a list of predefined goals that the virtual assistant 500 can assist the user to achieve. In certain instances, the user may purchase various goals 520 from a marketplace of predefined goals that the virtual assistant 500 can assist the user to achieve. Alternatively, the goals 520, action spaces 527, and user information 537 may be associated with the user profile 515 automatically by the virtual assistant. For example, the virtual assistant may obtain data 540 from input associated with the user from the client system or remote systems, analyze the data 540 pertaining to the input, identify user information 537 within the data 540 based on the analysis, and recommend or select the goals 520 and action spaces 527 for the user profile 515 based on the analysis. In some instances, a user can make adjustments or modifying the goals 525, action spaces 527 (including the rules, decisions trees, or vectors), and user information 537 within the user profile 515 using the virtual assistant application 505 or a separate application accessed via the client system. The user profile 515 may be stored in a data store 542. The data store 542 is one or more repositories for persistently storing and managing collections of data such as databases, files, key-value stores, search engines, message queues, the like, and combinations thereof.

In order to assist users, the virtual assistant 500 is further configured to process the data 540 and generate virtual content 543 to be displayed using, for example, a HMD as described with respect to FIGS. 2A, 2B, 3A, 3B, 4A, 4B, and 4C. The data 540 is obtained from input associated with the user. More specifically, the virtual assistant application 505 obtains the data 540 in a passive or active manner as the user utilizes the client system, e.g., wears the HMD while performing an activity. The data 540 is obtained using one or more I/O interfaces 545, which allow for communicating with external devices, such as a keyboard, game controllers, display devices, image capture devices, HMDs, and the like. Moreover, the one or more I/O interfaces 545 may include one or more wired or wireless NICs for communicating with a network, such as network 120 described with respect to FIG. 1. A passive manner means that the virtual assistant application 505 obtains data via the image capture devices, sensors, remote systems, the like, or combinations thereof without prompting the user with virtual content, e.g., text, audio, glimmers, etc. An active manner means that the virtual assistant application 505 obtains data via the image capture devices, sensors, remote systems, the like, or combinations thereof by prompting the user with virtual content, e.g., text, audio, glimmers, etc. The data 540 includes: (i) data regarding activity of the user in a physical environment, a virtual environment, or a combination thereof (e.g., an extended reality environment comprising images and audio of the user interacting in the physical environment and/or the virtual environment), (ii) data from external systems, or (iii) both. The virtual assistant application 505 forwards the data 540 to the virtual assistant engine 510 for processing.

In some embodiments, data 540 associated with sensors, active information, and/or passive information collected via the client system may be associated with one or more privacy settings. The data 540 may be stored on or otherwise associated with any suitable computing system or application, such as, for example, the social-networking system, the client system, a third-party system, a messaging application, a photo-sharing application, a biometric data acquisition application, an artificial-reality application, a virtual assistant application, and/or any other suitable computing system or application.

Privacy settings (or “access settings”) for the data 540 may be stored in any suitable manner; such as, for example, in association with data 540, in an index on an authorization server, in another suitable manner, or any suitable combination thereof. A privacy setting for data 540 may specify how the data 540 (or particular information associated with the data 540) can be accessed, stored, or otherwise used (e.g., viewed, shared, modified, copied, executed, surfaced, or identified) within an application (such as an artificial-reality application). When privacy settings for the data 540 allow a particular user or other entity to access that the data 540, the data 540 may be described as being “visible” with respect to that user or other entity. As an example, a user of an extended reality application or virtual assistant application 505 may specify privacy settings for a user profile 515 page that identify a set of users that may access the extended reality application extended reality application or virtual assistant application 505 information on the user profile 515 page, thus excluding other users from accessing that information. As another example, an extended reality application extended reality application or virtual assistant application 505 may store privacy policies/guidelines. The privacy policies/guidelines may specify what information of users may be accessible by which entities and/or by which processes (e.g., internal research, advertising algorithms, machine-learning algorithms), thus ensuring only certain information of the user may be accessed by certain entities or processes.

In some embodiments, privacy settings for the data 540 may specify a “blocked list” of users or other entities that should not be allowed to access certain information associated with the data 540. In some cases, the blocked list may include third-party entities. The blocked list may specify one or more users or entities for which the data 540 is not visible.

Privacy settings associated with the data 540 may specify any suitable granularity of permitted access or denial of access. As an example, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. In some embodiments, different pieces of the data 540 of the same type associated with a user may have different privacy settings. In addition, one or more default privacy settings may be set for each piece of data 540 of a particular data-type.

The data 540 is processed by the interaction module 547 of the virtual assistant engine 510 in a single occurrence, e.g., a single interface input or single activity, or across multiple occurrences, e.g., a dialog or days' worth of activity using various techniques (e.g., manual, batch, real-time or streaming, artificial intelligence, distributed, integrated, normalization, standardization, data mining, statistical, or like processing techniques) depending on how the data 540 is obtained and the type of data 540 to be processed. The processing of the data 540 extracts information 549 pertaining to the data and generates a structured representation of the extracted information 549.

The information extraction is the process of extracting specific information from the data 540. The specific information includes the objects, attributes, and relationships between objects in the data 540. The specific information extracted and the technique used for the extraction depends on the type of data 540 being processed. For example, if the user input is based on a text modality, the virtual assistant engine 510 may process the input using a messaging platform 550 having natural language processing capabilities to extract the specific information such as determining an intent of the text. If the user input is based on an audio modality (e.g., the user may speak to the virtual assistant application 505 or send a video including speech to the virtual assistant application 505), the virtual assistant engine 510 may process it using an automatic speech recognition (ASR) module 552 to convert the user input into text and use the messaging platform 550 to extract the specific information such as identifying named entities within the text. If the user input is based on an image or video modality, the virtual assistant engine 510 may process it using optical character recognition techniques within the messaging platform 550 to convert the user input into text and use the messaging platform 550 to extract the specific information such as identifying named entities within the text. If the user input is based on gestures and/or user interface actions, the virtual assistant engine 510 may process it using gesture and/or user interface recognition techniques within the processing system 555 (e.g., processing system 120 described with respect to FIG. 1) to extract the specific information such as identifying the gesture or user interface inputs. If the activity is observed by one or more image capture devices, then artificial intelligence platform 560 (e.g., computer vision, image analysis and classification, physical environment mapping, event, action, or task prediction, and the like) may be used to process the image or video data and extract the specific information such as determine the objects, attributes, and/or relationships between objects within an image observed by the image capture devices. If the activity is sensed by one or more sensors, then artificial intelligence platform 560 may be used to process the sensor data and determine the objects, attributes, and/or relationships detected by the sensors. If the data is received from remote systems, then messaging platform 550, ASR module 552, processing system 555, artificial intelligence platform 560, or a combination thereof may be used to process the remote system data and determine the objects, attributes, and/or relationships received from the remote system. The artificial intelligence platform 560 comprises rule based systems 562, algorithms 565, and models 567 for implementing rule-based artificial intelligence and machine learning based artificial intelligence.

Once information 549 is extracted, the interaction module 547 generates a structured representation of the extracted information 549. In particular embodiments, the structured representation is a context graph 575 (e.g., a scene graph). For example, given an image, downstream analysis involves not only detecting and recognizing objects in the image, but also learning the relationship between objects (visual relationship detection), and optionally generating a text description (image captioning) based on the image content. Alternatively, the downstream processing involves the virtual assistant engine 510 determining what a user in the image is doing (Visual Question Answering (VQA)), or even removing non-essential or irrelevant objects from the image and finding similar historical images (image editing and retrieval), etc. These tasks require a higher level of understanding and reasoning for image vision tasks. The context graph 575 is a structured representation of the data (e.g., an image), where nodes in the graph correspond to objects with their object categories, and edges correspond to their pairwise relationships between objects, and is capable of achieving the higher level of understanding and reasoning needed for image vision tasks.

The context graph 575 may be generated by the interaction module 547 using artificial intelligence platform 560. For example, the rule based systems 562, algorithms 565, and/or models 567 of the artificial intelligence platform 560 may be configured for any known scene graph generation (SGG) techniques such as conditional random field (CRF)-based SGG, TransE, TransH, TransR and PTransE-based SGG, convolutional neural network (CNN)-based SGG, recurrent neural network/long short-term memory (RNN/LSTM)-based SGG, and graph-based SGG. In general, the generation process includes one or more models performing object detection, relationship detection, and optional caption generation processes, and predicting the results using context information corresponding to each process. To generate the context graph, the object detection layer detects the objects, and a relationship detection layer predicts the relationships between object pairs. For detection of inter-object relationships, the context information for the corresponding objects is used. For the optional caption generation, the context information for objects in the caption regions and their relationships is used. The context features used in the relationship detection and caption generation may be extracted through one or more neural networks such as regions with convolutional neural networks (R-CNN) and/or a CCN. The context graph 575 for data 540 may be expressed as a triple set of <subject predicate object> form, which is comprised of subject, object and the relationships between the subject and object. The context graph 575 is then stored as metadata with the data 540 in the data store 542.

The interaction module 547 determines one or more interactions 515 to be presented, initiated, or executed for the user based on the context graph 575. In some instances, the determination includes: for each of the action spaces 527, the interaction module 547 inputting the values for the subject, object and the relationships between them into the sets of rules or decisions trees 530 that connect context 532 to the action spaces 527, and obtaining output concerning whether an interaction associated with each of the action spaces should be presented, initiated, or executed. For example, given a context graph comprising the following values: the current time is 7 AM, it is currently raining, the outside temperature is 67 degrees, the user is located at home, and the user is scheduled to go to work for 8 AM, these values may be input into a decision tree that includes the following conditions: when the weather is rain, the outside temperature is less than 70 degrees, and the user is leaving the home, the determinative output is to present the interaction—“recommend user wear a rain coat” to the user.

Alternatively, context graph 575 may be embedded into a vector (e.g., using a Siamese graph model) to represent global information and contextual content of the data 540. The interaction module 547 determines one or more interactions 515 to be presented, initiated, or executed for the user based on the vectors derived from the context graph 575. In some instances, the determination includes: for each of the action spaces 527, the interaction module 547 compares a vector of parameters associated with context graph 575 to a vector of parameters that connect context 532 to the action spaces 527 to identify a given interaction that should be presented, initiated, or executed. For example, a present vector of parameters including: the current time is 7 AM, it is currently raining, the outside temperature is 67 degrees, the user is located at home, and the user is scheduled to go to work for 8 AM is compared to a vector of parameters including: weather is rain, the outside temperature is less than 70 degrees, and the user leaving home to go to work. The comparison of vectors may be performed using any know technique or algorithm such as using a k-means algorithm. When the comparison indicates a substantial match between vectors of parameters (e.g., a similar score greater than a predefined threshold), the determinative output is to present the interaction associated with action space—“recommend user wear a raincoat” to the user.

Once one or more interactions 515 are determined to be presented, initiated, or executed for the user, the virtual content module 580 determines virtual content 543 to be displayed to the user via the client system based on virtual content data 585 in order to present, initiate, or execute the one or more interactions 515. In various embodiments, the virtual content data 585 is defined and coded by a developer and included as part of the virtual assistant. For example, a developer may define and code virtual content data 585 for the action spaces 527 in order to assist the user with achieving the goals 520. For example, with reference back to FIG. 5B, virtual content data 585 may be defined and coded for the action space 527 (A), which includes: (i) a glimmer to be positioned and displayed on a yoga mat in order to present the interaction 515 (A) to a user, (ii) an outline of pose A to be positioned and displayed on a yoga mat in order to initiate interaction 515 (A), and (iii) the various poses A-C with audio instructions on how to perform tasks 522 (A) displayed in the user field of view in order to execute the interaction 515 (A).

The determined virtual content 543 may be generated and rendered by the virtual content module 580, as described in detail with respect to FIGS. 2A, 2B, 3A, 3B, 4A, 4B, and 4C. For example, the virtual content module 580 may trigger generation and rendering of virtual content 543 by the client system (including virtual assistant application 505 and I/O interfaces 545) based on a current field of view of user, as may be determined by real-time gaze tracking of the user, or other conditions. More specifically, image capture devices of the sensors capture image data representative of objects in the real world, physical environment that are within a field of view of image capture devices. During operation, the client system performs object recognition within image data captured by the image capture devices of HMD to identify objects in the physical environment such as the user, the user's hand, and/or physical objects. Further, the client system tracks the position, orientation, and configuration of the objects in the physical environment over a sliding window of time. Field of view typically corresponds with the viewing perspective of the HMD. In some examples, the extended reality application presents extended reality content comprising mixed reality and/or augmented reality. The extended reality application may render virtual content 543, such as virtual information or objects on a transparent display such that the virtual content 543 is overlaid on real-world objects, such as the portions of the user, the user's hand, physical objects, that are within a field of view of the user. In other examples, the extended reality application may render images of real-world objects, such as the portions of the user, the user's hand, physical objects, that are within field of view along with virtual content 543, such as virtual information or objects within extended reality content. In other examples, the extended reality application may render virtual representations of the portions of the user, the user's hand, physical objects that are within field of view (e.g., render real-world objects as virtual objects) within extended reality content.

### Interaction and Interface Techniques

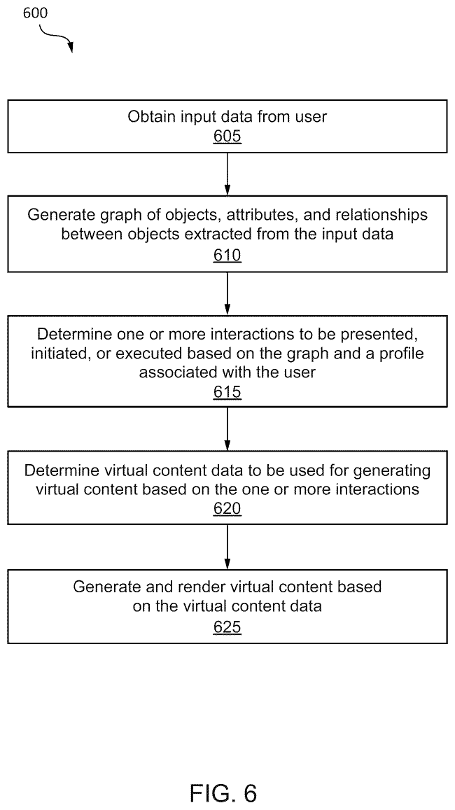

FIG. 6 is a flowchart illustrating a process 600 for presenting, initiating, and/or executing an interaction with a user according to various embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the steps may be performed in some different order or some steps may also be performed in parallel. In certain embodiments, such as in an embodiment depicted in FIGS. 1, 2A, 2B, 3A, 3B, 4A, 4B, 4C, 5A, and 5B, the processing depicted in FIG. 6 may be performed by a client system implementing a virtual assistant to present, initiate, and/or execute an interaction with a user.

At step 605, input data is obtained from a user. The input data includes: (i) data regarding activity of the user in an extended reality environment (e.g., images and audio of the user interacting in the physical environment and/or the virtual environment), (ii) data from external systems, or (iii) both. The input data may be obtained by a client system that comprises at least a portion of the virtual assistant. In certain instances, the client system is a HMD as described in detail herein.

At step 610, a virtual assistant generates a graph of objects, attributes, and relationships between objects extracted from the input data. The graph is expressed in a form comprising a subject, an object and relationships between the subject and the object. In certain instances, the graph is generated using a SGG technique such as CRF-based SGG, TransE, TransH, TransR and PTransE-based SGG, CNN-based SGG, RNN/LSTM-based SGG, or graph-based SGG.

At step 615, the virtual assistant determines one or more interactions to be presented, initiated, or executed based on the graph and a profile associated with the user. The profile comprises a plurality of goals and associated action spaces. The action spaces are defined and encoded as sub-hierarchical structures comprised of interactions, tasks, and workflows. The interactions are further defined using sets of rules, decisions trees, or vectors. The rules, decisions trees, or vectors connect context to the action spaces and enable the virtual assistant engine to determine whether a given interaction should be presented to a user and/or initiated based on the context. The context comprises the circumstances that form the setting for the activity of the user in the physical environment, the virtual environment, or the combination thereof. The determining the one or more interactions comprises: (i) inputting values of the graph into the rules or decisions trees to determine the one or more interactions, or (ii) embedding the context graph into a context vector and comparing the context vector to the vectors to determine the one or more interactions.

At step 620, the virtual assistant determines virtual content data to be used for rendering virtual content based on the one or more interactions. The action spaces further comprise virtual content data defined and coded for the action spaces in order to assist the user with achieving the goals. Determining the virtual content data comprises mapping the one or more interactions to respective action spaces and determining the virtual content data associated with the respective actions spaces.

At step 625, the virtual content is generated and rendered by the client system in the extended reality environment displayed to the user based on the virtual content data. The virtual content is used by the client system to present, initiate, or execute the one or more interactions for the user.

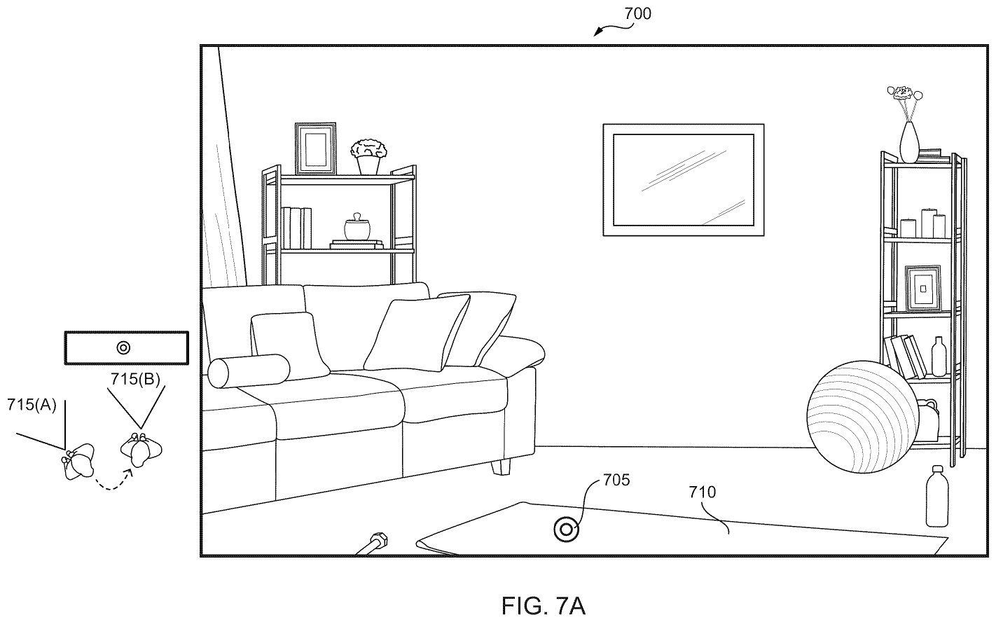

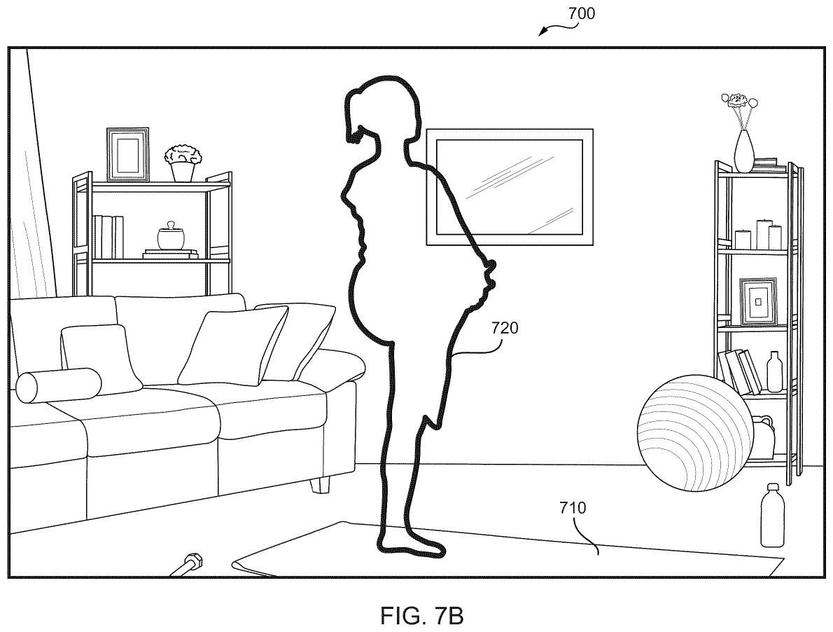

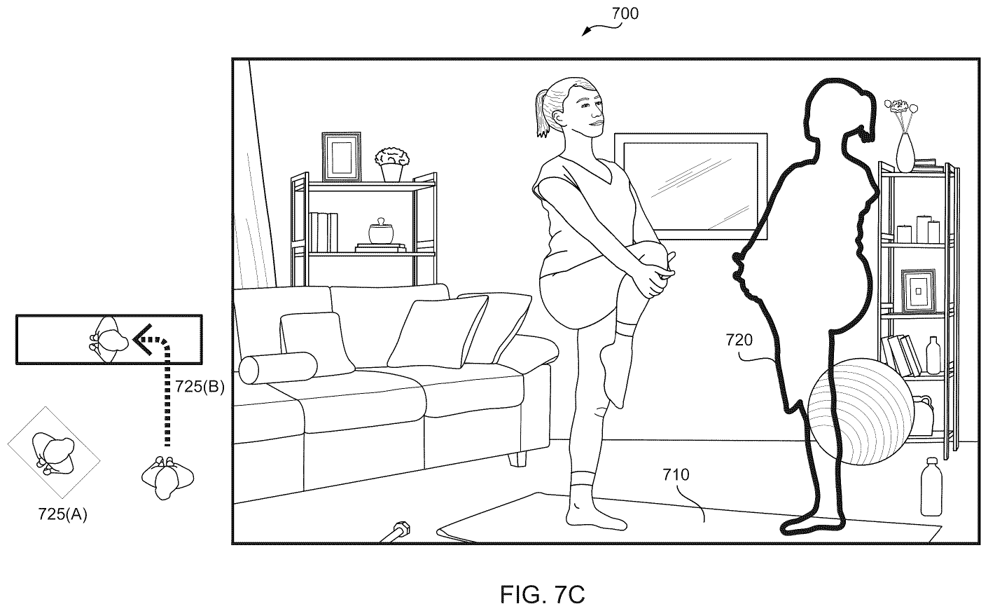

FIGS. 7A-7C illustrate presenting, initiating, and executing the one or more interactions in an extended reality environment 700 via the virtual content generated and rendered in process 600. FIG. 7A shows that the virtual assistant has determined that, based on context of a user's present input data, an interaction: yoga regimen—should be recommended to the user to achieve an immediate goal of completing today's exercise (which goes towards achieving an intermediate goal of completing an exercise challenge and a long term goal of being fit). In order to present this recommendation to the user, the virtual assistant determines that the yoga regimen has an action space that defines virtual content data for presenting the yoga regimen to the user. The virtual content data codes for virtual content such as a glimmer 705 (e.g., a focal point) to be placed on a physical object such as yoga equipment 710 (e.g., a yoga mat). The virtual content data is used by the client system to generate and render the glimmer 705 in the extended reality environment 700 displayed to the user. The purpose of the glimmer 705 is to gain the attention of the user and signal that the virtual assistant has information (e.g., a possible interaction) to convey to the user.

At this phase, the user can: 715(A) ignore the glimmer 705 (e.g., unaware or convey disinterest in exercising at the moment) or 715(B) focus on the glimmer 705 (e.g., convey interest in exercising at the moment). The virtual assistant receives new data including the eye gaze of the user and executes process 600 based on the new data. If the graph determined by the virtual assistant for the new data includes the eye gaze of the user focused somewhere other than the glimmer 705 [715(A)], the virtual assistant determines either no interactions or one or more other interactions (other than yoga regimen) are satisfied by the context of the new data. The virtual assistant then updates the virtual content based on the new data, for example, removes the glimmer 705, leaves the glimmer to determine if the user changes their mind over time, or presents new virtual content based on the one or more other interactions. Alternatively, if the graph determined by the virtual assistant for the new data includes the eye gaze of the user focused on the glimmer 705, the virtual assistant determines the yoga regimen remains satisfied by the context of the new data and the virtual assistant has the attention of the user to initiate the yoga regimen.

As shown in FIG. 7B, once the virtual assistant has the attention of the user, in order to initiate the yoga regimen, the virtual assistant determines that the yoga regimen has an action space that defines virtual content data for initiating the yoga regimen to the user. The virtual content data codes for virtual content such as an outline 720 of a first yoga pose to be placed on a physical object such as yoga equipment 710 (e.g., a yoga mat). The virtual content data is used by the client system to generate and render the outline 720 in the extended reality environment 700 displayed to the user. As should be understood, the virtual content data may be associated with a particular action space but also in a more fine-grained manner may also be associated with a particular workflow or task within the action space. For example, if the given instance is the user's first execution of the interaction—yoga regimen, then virtual content data for a beginner's workflow (e.g., morning flow #1) may be determined and used to generate the virtual content (outline 720). Alternatively, if the user has been following a set of workflows for the yoga regime interaction, then the virtual content data may be determined to reflect the current workflow that the user is on and the virtual assistant picks up with the virtual content (outline different from that of 720) where the last workflow ended (e.g., morning flow #3). Further, it should be understood that the workflows associated with an interaction can be modified by the user (e.g., add or remove workflow or add or remove task within individual workflows), or the workflows and tasks can be updated, for example, by the user downloading new workflows or version updates for interactions being pushed to the client system.

As shown in FIG. 7C, at this phase, the user can: 725(A) ignore the outline 720 (e.g., convey disinterest in the yoga regimen or particular pose) or 725(B) assume the pose shown by outline 720 (e.g., convey interest in continuing the yoga regimen). The virtual assistant receives new data including an image of the user and executes process 600 based on the new data. If the graph determined by the virtual assistant for the new data includes an image of the user not taking the pose conveyed by outline 720 [725(A)], the virtual assistant determines no interactions are satisfied by the context of the new data, one or more other interactions (other than yoga regimen) are satisfied by the context of the new data, or the yoga regimen is satisfied but the particular workflow is not satisfied. The virtual assistant then updates the virtual content based on the new data, for example, removes the outline 720, leaves the outline 720 to see if the user changes their mind over time, presents new virtual content based on the one or more other interactions, or replaces the outline 720 with a different outline indicating a change in workflow. Alternatively, if the graph determined by the virtual assistant for the new data includes an image of the user assuming the pose shown by outline 720, the virtual assistant determines the yoga regimen remains satisfied by the context of the new data and the virtual assistant has the approval of the user to execute the yoga regimen with the given workflow. Once the yoga regimen is executed, the digital assistant can guide the user through the yoga regime in accordance with the tasks (e.g., poses) and virtual content data associated with the workflow (e.g., displaying outlines for poses B-K in succession). The virtual assistant continues to execute process 600 (e.g., continuously, semi-continuously, or periodically) through-out execution of the yoga regimen to ensure the user remains engaged and is following the tasks defined for the workflow or to determine whether a new interaction is trigged by the context of the new data.

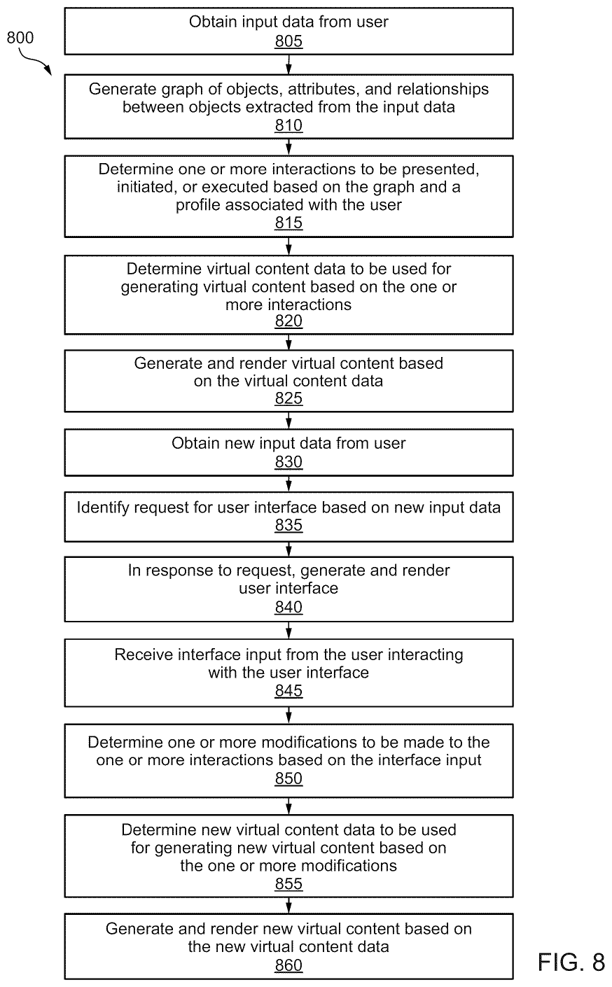

FIG. 8 is a flowchart illustrating a process 800 for making a modification to an interaction proposed by the virtual assistant according to various embodiments. The processing depicted in FIG. 8 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain alternative embodiments, the steps may be performed in some different order, or some steps may also be performed in parallel. In certain embodiments, such as in an embodiment depicted in FIGS. 1, 2A, 2B, 3A, 3B, 4A, 4B, 4C, 5A, and 5B, the processing depicted in FIG. 8 may be performed by a client system implementing a virtual assistant to present, initiate, and/or execute an interaction with a user.

At step 805, input data is obtained from a user. The input data includes: (i) data regarding activity of the user in an extended reality environment (e.g., images and audio of the user interacting in the physical environment and/or the virtual environment), (ii) data from external systems, or (iii) both. The input data may be obtained by a client system that comprises at least a portion of the virtual assistant. In certain instances, the client system is a HMD as described in detail herein.

At step 810, the virtual assistant generates a graph of objects, attributes, and relationships between objects extracted from the input data. The graph is expressed in a form comprising a subject, an object and relationships between the subject and the object. In certain instances, the graph is generated using a SGG technique such as CRF-based SGG, TransE, TransH, TransR and PTransE-based SGG, CNN-based SGG, RNN/LSTM-based SGG, or graph-based SGG.

At step 815, the virtual assistant determines one or more interactions to be presented, initiated, or executed based on the graph and a profile associated with the user. The profile comprises a plurality of goals and associated action spaces. The action spaces are defined and encoded as sub-hierarchical structures comprised of interactions, tasks, and workflows. The interactions are further defined using sets of rules, decisions trees, or vectors. The rules, decisions trees, or vectors connect context to the action spaces and enable the virtual assistant engine to determine whether a given interaction should be presented to a user and/or initiated based on the context. The context comprises the circumstances that form the setting for the activity of the user in the physical environment, the virtual environment, or the combination thereof. The determining the one or more interactions comprises: (i) inputting values of the graph into the rules or decisions trees to determine the one or more interactions, or (ii) embedding the context graph into a context vector and comparing the context vector to the vectors to determine the one or more interactions.

At step 820, the virtual assistant determines virtual content data to be used for rendering virtual content based on the one or more interactions. The action spaces further comprise virtual content data defined and coded for the action spaces in order to assist the user with achieving the goals. Determining the virtual content data comprises mapping the one or more interactions to respective action spaces and determining the virtual content data associated with the respective actions spaces.

At step 825, the virtual content is generated and rendered by the client system in the extended reality environment displayed to the user based on the virtual content data. The virtual content is used by the client system to present, initiate, or execute the one or more interactions for the user.

At step 830, new input data is obtained from the user. The new input data includes: (i) new data regarding activity of the user in the extended reality environment (e.g., images and audio of the user interacting in the physical environment and/or the virtual environment), (ii) new data from external systems, or (iii) both. The new input data may be obtained by the client system.

At step 835, the client system identifies a request by the user for a user interface to interact with the virtual assistant based on the new input data. In some instances, the client system identifies a gesture or combination of gestures performed by the user based on the new input data. The gesture or combination of gestures is indicative of a request for a user interface to interact with the virtual assistant.

At step 840, in response to request by the user for a user interface, the client system generates and renders the user interface in the extended reality environment displayed to the user. The user interface includes one or more user interface elements for interacting with the virtual assistant. In some instances, the user interface is rendered at a position locked relative to a physical or virtual object. For example, the client system may generate and render a user interface including one or more user interface elements (e.g., virtual buttons) on the surface of a physical object.

At step 845, the virtual assistant receives interface input from the user interacting with the user interface.

At step 850, the virtual assistant determines one or more modifications to be made to one or more interactions based on the interface input. In some instances, the one or more modifications change one or more of the tasks to be executed for the one or more interactions. In other instances, the modifications change one or more of the workflows to be executed for the one or more interactions. In other instances, the one or more modifications provide one or more other interactions to be initiated for the user.

At step 855, the virtual assistant determines new virtual content data to be used for generating new virtual content based on one or more modifications. For example, the virtual assistant may determine new virtual content for the changed task(s), workflow(s), interaction(s), or combination thereof.

At step 860, the new virtual content is generated and rendered by the client system in the extended reality environment displayed to the user based on the new virtual content data. The new virtual content is used by the client system to present, initiate, or execute one or more interactions (or one or more other interactions) with one or more modifications for the user.

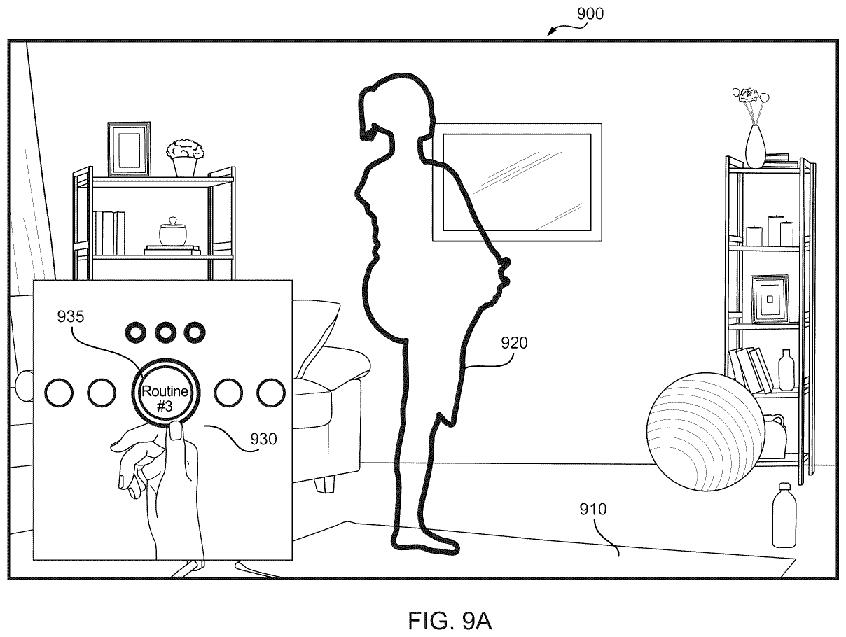

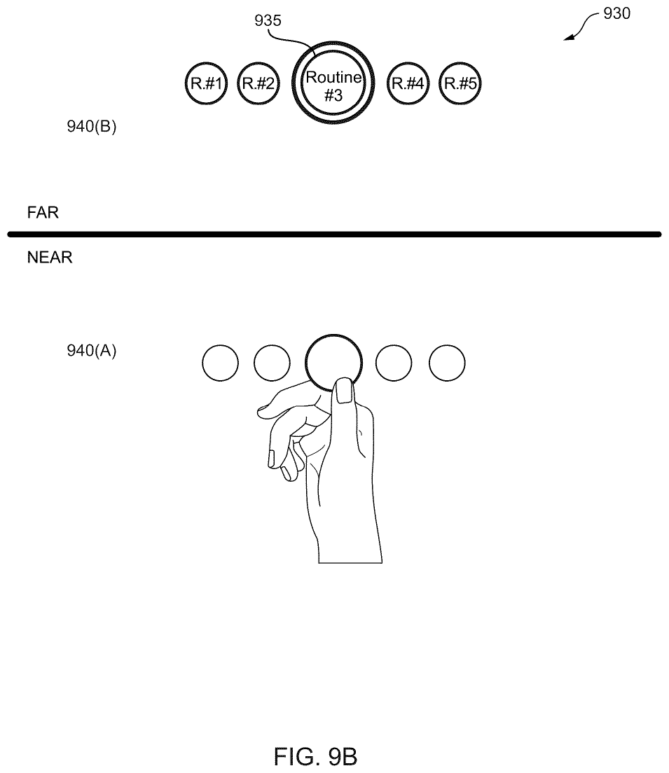

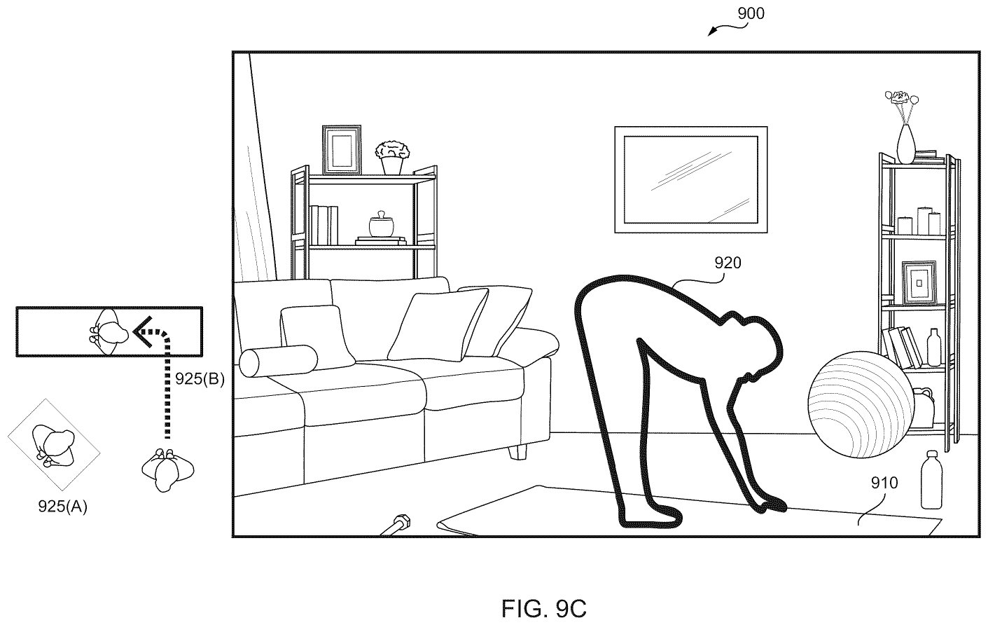

FIGS. 9A-9C illustrate presenting, initiating, and executing one or more interactions in an extended reality environment 900 via the virtual content generated and rendered in process 800. As shown in FIG. 9A, continuing with the example described with respect to FIGS. 7A-7C, once the virtual assistant has the attention of the user, in order to initiate the yoga regimen, the virtual assistant determines that the yoga regimen has an action space that defines virtual content data for initiating the yoga regimen to the user. The virtual content data codes for virtual content such as an outline 920 of a first yoga pose to be placed on a physical object such as yoga equipment 910 (e.g., a yoga mat). The virtual content data is used by the client system to generate and render outline 920 in the extended reality environment 900 displayed to the user.

As further shown in FIG. 9A, at this phase, the user may decide to make a modification to the interaction—yoga regimen proposed by the virtual assistant. In some instances, the user may decide to make a minor modification to change one or more of the tasks to be executed for the one or more interactions, or the one or more workflows to be executed for the one or more interactions. For example, the user may decide that they do want to initiate the yoga regimen, but they want to go off script today. In order to make the modification, the user can request that the client system render a user interface 930 to interact with the virtual assistant and communicate the modification. As should be understood, the request for a minor modification to the presented one or more interactions can be made at any time/phase up till completion of the one or more interactions (e.g., after the presenting, prior to, during, or after the initiating, or prior to or during the executing the one or more interactions such as when the yoga regimen is first presented to the user via a glimmer).

In response to the request by the user for the user interface 930, the client system generates and renders the user interface 930 in the extended reality environment 900 displayed to the user. The user interface 930 visualizes information such as modification suggestions 935 made by the virtual assistant based on available data (e.g., workflows and/or tasks) defined within the action space for the interaction—yoga regimen. The user can use a gesture or combination of gestures to navigate through the user interface 930 and view and/or select suggestions 935. In some instances, as shown in FIG. 9B, when the user navigates the user interface 930, the information is available to be displayed both at the hand 940(A) and near the physical object 940(B) such as the yoga equipment 910. The intention is not for the user to focus back and forth between both displays, but to offer guidance on how to interact when the user needs it. Advantageously, this set-up also addresses the preference of the user to consume information near the hand or from afar.

As shown in FIG. 9C, the virtual assistant receives interface input from the user interacting with the user interface. the virtual assistant determines one or more modifications (e.g., change one or more of the tasks or workflows) to be made to the one or more interactions based on the interface input (e.g., selection of Routine #4). The virtual assistant also determines virtual content data to be used for generating virtual content based on the one or more modifications (e.g., virtual content data associated with the Routine #4). The virtual content data codes for virtual content such as an outline 920 of a first yoga pose to be placed on a physical object such as yoga equipment 910 (e.g., a yoga mat). The virtual content data is used by the client system to generate and render outline 920 in the extended reality environment 900 displayed to the user.

At this phase, the user can: 925(A) ignore the outline 920 (e.g., convey disinterest in the yoga regimen or particular pose) or 925(B) assume the pose shown by outline 920 (e.g., convey interest in continuing the yoga regimen). The virtual assistant receives new data including an image of the user and executes process 900 based on the new data. If the graph determined by the virtual assistant for the new data includes an image of the user not taking the pose conveyed by outline 920 [925(A)], the virtual assistant determines no interactions are satisfied by the context of the new data, one or more other interactions (other than yoga regimen) are satisfied by the context of the new data, or the yoga regimen is satisfied but the particular workflow is not satisfied. The virtual assistant then updates the virtual content based on the new data, for example, removes the outline 920, leaves the outline 920 to see if the user changes their mind over time, presents new virtual content based on the one or more other interactions, or replaces the outline 920 with a different outline indicating a change in workflow. Alternatively, if the graph determined by the virtual assistant for the new data includes an image of the user assuming the pose shown by outline 920, the virtual assistant determines the yoga regimen remains satisfied by the context of the new data and the virtual assistant has the approval of the user to execute the yoga regimen with the given workflow. Once the yoga regimen is executed, the digital assistant can guide the user through the yoga regime in accordance with the tasks (e.g., poses) and virtual content data associated with the workflow (e.g., displaying outlines for poses B-K in succession). The virtual assistant continues to execute process 900 (e.g., continuously, semi-continuously, or periodically) through-out execution of the yoga regimen to ensure the user remains engaged and is following the tasks defined for the workflow or to determine whether a new interaction or modification is trigged by the context of the new data.

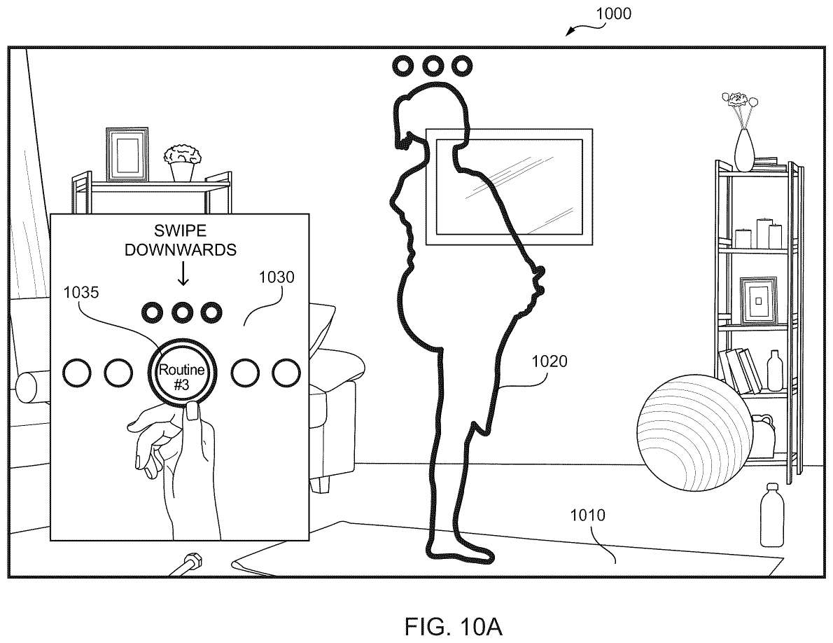

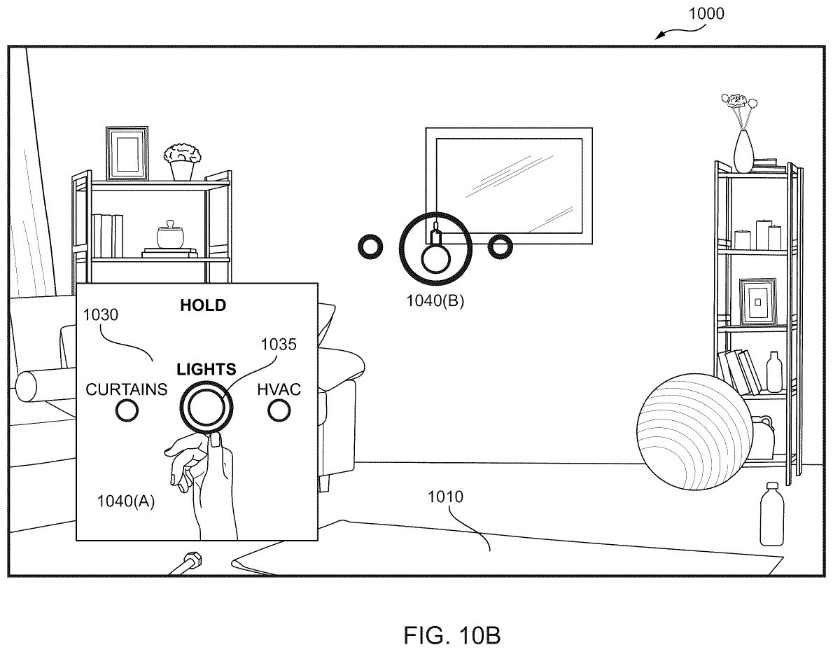

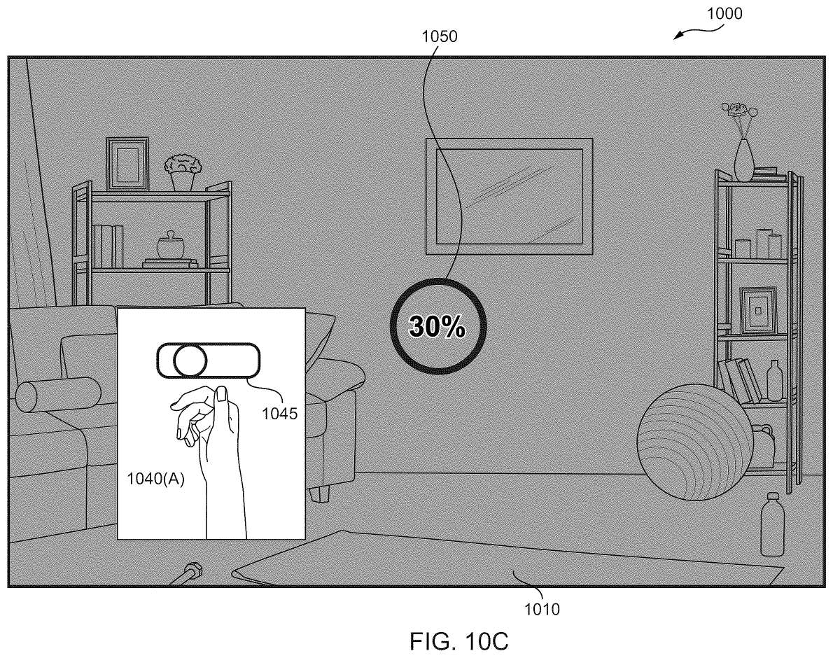

FIGS. 10A-10C illustrate presenting, initiating, and executing one or more interactions in an extended reality environment 1000 via the virtual content generated and rendered in process 800. As shown in FIG. 10A, continuing with the example described with respect to FIGS. 9A-9C, once the virtual assistant has the attention of the user, to initiate the yoga regimen, the virtual assistant determines that the yoga regimen has an action space that defines virtual content data for initiating the yoga regimen to the user. The virtual content data codes for virtual content such as an outline 1020 of a first yoga pose to be placed on a physical object such as yoga equipment 1010 (e.g., a yoga mat). The virtual content data is used by the client system to generate and render the outline 1020 in the extended reality environment 1000 displayed to the user.

As further shown in FIG. 10A, at this phase, the user may decide to make a modification to the interaction—yoga regimen proposed by the virtual assistant. In some instances, the user may decide to make a major modification to change the one or more interactions to be presented, initiated, or executed. For example, the user may decide that they do not want to continue with the yoga regimen, but instead would like the light to be less intense today, for whatever reason. In order to make the modification, the user can request that the client system render a user interface 1030 to interact with the virtual assistant and communicate the modification. As should be understood, the request for a major modification to the presented one or more interactions can be made at any time/phase, even prior to the presentation of the one or more interactions or after the execution of the one or more interactions (e.g., if the user simply wants to initiate an interaction with the virtual assistant).

In response to the request by the user for the user interface 1030, the client system generates and renders the user interface 1030 in the extended reality environment 1000 displayed to the user. The user interface 1030 visualizes information such as modification suggestions 1035 made by the virtual assistant based on available data (e.g., other interactions that may satisfy at least part of the context of the current input data, historical interactions performed by the user, interactions similar to presently recommend one or more interactions, all interactions available to the user, etc.). The user can use a gesture or combination of gestures to navigate through the user interface 1030 and view and/or select suggestions 1035. In some instances, as shown in FIG. 10B, when the user navigates the user interface 1030, the information is available to be displayed both at the hand 1040(A) and near a physical object 1040(B) such as the lights, wall, or ceiling 1010. The intention is not for the user to focus back and forth between both displays, but to offer guidance on how to interact when the user needs it. Advantageously, this set-up also addresses the preference of the user to consume information near the hand or from afar.

As shown in FIGS. 10B and 10C, the virtual assistant receives interface input from the user interacting with the user interface. The virtual assistant determines one or more modifications to be made to the one or more interactions based on the interface input (e.g., selection of a new interaction—lights). In some instances, the user interaction may execute one or more modifications, e.g., automatically execute the interaction—lights, if the virtual assistant has a defined setting for light intensity. In some instances, the virtual assistant additionally or alternatively determines virtual content data to be used for generating virtual content based on one or more modifications (e.g., virtual content data associated with the interaction—lights). For example, the user may choose to start the light interaction, and if the virtual assistant does not have a defined setting for the light intensity or if the user wants to change the defined setting for the light intensity, the user is able to hold down the light button and access another virtual interface 1045 (the virtual content data codes for virtual content such as another user interface generated based on one or more modifications). The virtual content data is used by the client system to generate and render the virtual interface 1045 in the extended reality environment 1000 displayed to the user. Still holding the virtual interface 1045, the user is able to communicate interface input to the virtual assistant by a gesture (e.g., sliding) with the virtual interface 1045 to adjust the light intensity 1050 accordingly.

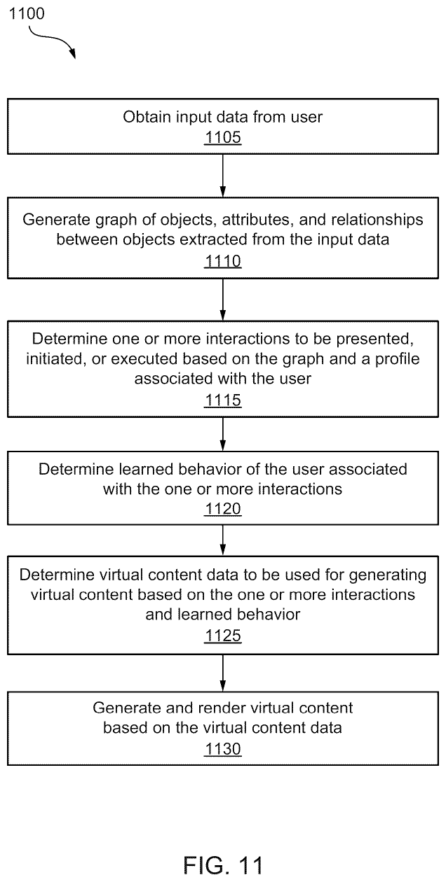

FIG. 11 is a flowchart illustrating a process 1100 for presenting, initiating, and/or executing an interaction with learned behavior cues according to various embodiments. The processing depicted in FIG. 11 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 11 and described below is intended to be illustrative and non-limiting. Although FIG. 11 depicts the various processing steps occurring in a particular sequence or order, this is not intended to be limiting. In certain alternative embodiments, the steps may be performed in some different order or some steps may also be performed in parallel. In certain embodiments, such as in an embodiment depicted in FIGS. 1, 2A, 2B, 3A, 3B, 4A, 4B, 4C, 5A, and 5B, the processing depicted in FIG. 11 may be performed by a client system implementing a virtual assistant to present, initiate, and/or execute an interaction with a user.

At step 1105, input data is obtained from a user. The input data includes: (i) data regarding activity of the user in an extended reality environment (e.g., images and audio of the user interacting in the physical environment and/or the virtual environment), (ii) data from external systems, or (iii) both. The input data may be obtained by a client system that comprises at least a portion of the virtual assistant. In certain instances, the client system is a HMD as described in detail herein.

At step 1110, the virtual assistant generates a graph of objects, attributes, and relationships between objects extracted from the input data. The graph is expressed in a form comprising a subject, an object and relationships between the subject and the object. In certain instances, the graph is generated using a SGG technique such as CRF-based SGG, TransE, TransH, TransR and PTransE-based SGG, CNN-based SGG, RNN/LSTM-based SGG, or graph-based SGG.

At step 1115, the virtual assistant determines one or more interactions to be presented, initiated, or executed based on the graph and a profile associated with the user. The profile comprises a plurality of goals and associated action spaces. The action spaces are defined and encoded as sub-hierarchical structures comprised of interactions, tasks, and workflows. The interactions are further defined using sets of rules, decisions trees, or vectors. The rules, decisions trees, or vectors connect context to the action spaces and enable the virtual assistant engine to determine whether a given interaction should be presented to a user and/or initiated based on the context. The context comprises the circumstances that form the setting for the activity of the user in the physical environment, the virtual environment, or the combination thereof. The determining the one or more interactions comprises: (i) inputting values of the graph into the rules or decisions trees to determine the one or more interactions, or (ii) embedding the context graph into a context vector and comparing the context vector to the vectors to determine the one or more interactions.

At step 1120, the virtual assistant determines learned behavior of the user associated with the one or more interactions using rule-based artificial intelligence, machine learning based artificial intelligence, or both. The determining the learned behavior may comprise collecting historical input data from the user. The historical input data comprises: (i) historical data regarding activity of the user in the extended reality environment, (ii) historical data from the external systems, or (iii) both. For example, the virtual assistant may have learned user preferences or typical user performance for the one or more interactions based on historical data associated with executing the one or more interactions or similar interactions for the user. The historical data may be used to retrain or fine tune rule based systems, algorithms, and models for implementing the rule-based artificial intelligence and the machine learning based artificial intelligence. The retrained or fine-tuned rule based systems, algorithms, and models may be implemented prior to initiation or execution of the one or more interactions to determine learned behavior for the one or more interactions. In some instances, the learned behavior for the one or more interactions can be linked or associated with the active spaces, workflows, or tasks for the one or more interactions.

At step 1125, the virtual assistant determines virtual content data to be used for generating virtual content based on the one or more interactions and the learned behavior of the user. The action spaces further comprise virtual content data defined and coded for the action spaces in order to assist the user with achieving the goals. Determining the virtual content data comprises mapping the one or more interactions to respective action spaces and determining the virtual content data associated with the respective actions spaces and learned behavior.

At step 1130, the virtual content is generated and rendered by the client system in an extended reality environment displayed to the user based on the virtual content data. The virtual content is used by the client system to present, initiate, or execute one or more interactions for the user.

As should be understood, one or more modifications of the interactions, workflows, tasks, and/or learned behavior can be made in accordance with the processes described with respect to process 800.

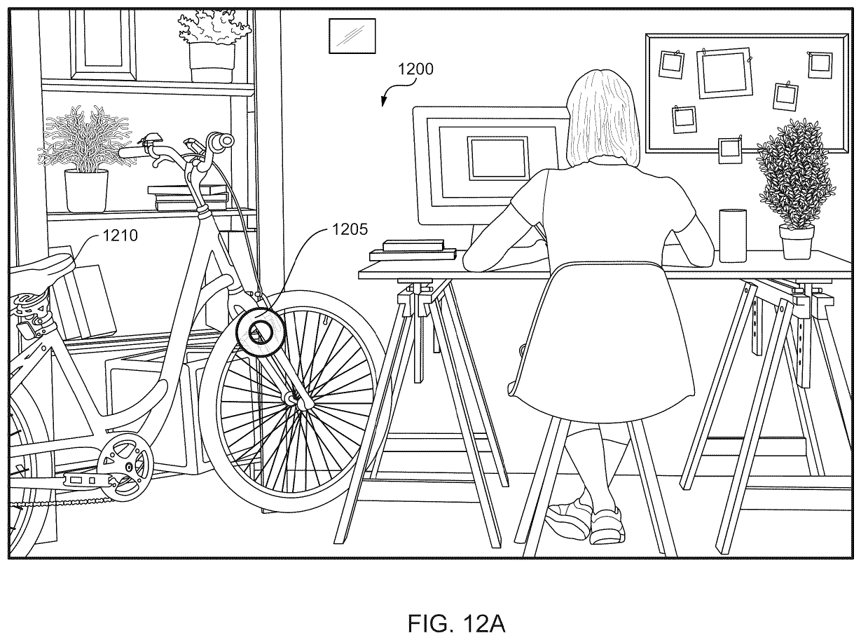

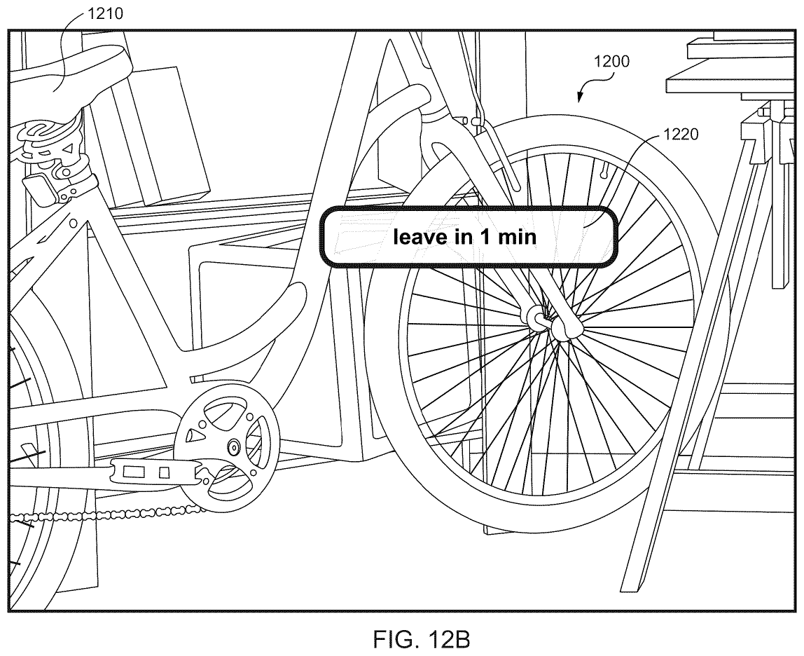

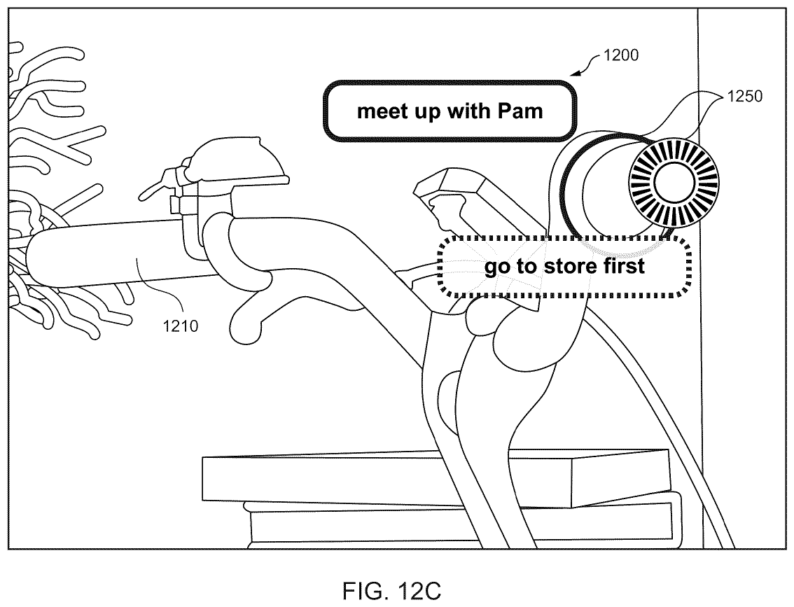

FIGS. 12A-12C illustrate presenting, initiating, and executing one or more interactions with learned behavior cues in an extended reality environment 1200 via the virtual content generated and rendered in process 1100. FIG. 12A shows that the virtual assistant has determined that, based on context of a user's present input data, an interaction: meet a friend glimmer—should be recommended to the user to achieve an immediate goal of plan tasks for meetup (which goes towards achieving an intermediate goal of finishing a workday and a long-term goal of being active/healthy). The context in this particular instance is that the user is working from home and finishes up a few work tasks before having to meet up with a friend. The user will be biking to the destination of the meet up with the friend. In order to present this recommendation to the user, the virtual assistant determines that the meet a friend interaction has an action space that defines virtual content data for presenting the meet a friend interaction to the user. The virtual content data codes for virtual content such as a glimmer 1205 (e.g., a focal point) to be placed on a physical object such as the bicycle 1210. The virtual content data is used by the client system to generate and render the glimmer 1205 in the extended reality environment 1200 displayed to the user. The purpose of the glimmer 1205 is to gain the attention of the user and signal that the virtual assistant has information (e.g., a possible interaction) to convey to the user.

At this phase, the user can: ignore glimmer 1205 (e.g., unaware or convey disinterest in the information) or focus on glimmer 1205 (e.g., convey interest in the information at the moment). The virtual assistant receives new data including the eye gaze of the user and executes process 1100 based on the new data. If the graph determined by the virtual assistant for the new data includes the eye gaze of the user focused somewhere other than the glimmer, the virtual assistant determines either no interactions or one or more other interactions (other than meet a friend) are satisfied by the context of the new data. The virtual assistant then updates the virtual content based on the new data, for example, removes the glimmer 1205, leaves the glimmer to determine if the user changes their mind over time, or presents new virtual content based on the one or more other interactions. Alternatively, if the graph determined by the virtual assistant for the new data includes the eye gaze of the user focused on the glimmer 1205, the virtual assistant determines the meet a friend interaction remains satisfied by the context of the new data and the virtual assistant has the attention of the user to initiate the meet a friend interaction. For example, between the user's final works task, the user may quickly glance over at bicycle 1210. When the client system and virtual assistant register the user's attention, the virtual assistant may initiate the meet a friend interaction.

As shown in FIG. 12B, once the virtual assistant has the attention of the user, in order to initiate the meet a friend interaction, the virtual assistant determines that the meet a friend interaction has an action space that defines virtual content data for initiating the meet a friend interaction to the user. The virtual content data codes for virtual content such as a countdown 1220 notifying the user when they should start making their way to meet the friend, which may be placed on a physical object such as the bicycle 1210. The virtual content data is used by the client system to generate and render the countdown 1220 in the extended reality environment 1200 displayed to the user.

As shown in FIG. 12C, at this phase, the user can: ignore the countdown 1220 (e.g., convey disinterest in the meet a friend interaction at the current time) or interact with the physical object such as the bicycle 1210. For example, the user may log off their computer and proceed to interact with bicycle 1210. The virtual assistant receives new data including an image of the user and executes process 1100 based on the new data. If the graph determined by the virtual assistant for the new data includes an image of the user not interacting with the bicycle 1210, the virtual assistant determines no interactions are satisfied by the context of the new data, one or more other interactions (other than meet the friend) are satisfied by the context of the new data, or the meet a friend interaction is satisfied but the particular workflow (e.g., meeting Pam; instead the user intends to meet with Rob first) is not satisfied. The virtual assistant then updates the virtual content based on the new data, for example, removes the countdown 1220, leaves the countdown 1220 to see if the user changes their mind over time, presents new virtual content based on one or more other interactions or replaces the countdown 1220 with a different the countdown 1220 or map indicating a change in workflow. Alternatively, if the graph determined by the virtual assistant for the new data includes an image of the user interacting with the bicycle 1210, the virtual assistant determines the meet a friend interaction remains satisfied by the context of the new data and the virtual assistant has the approval of the user to execute the meet a friend interaction with the given workflow.

Once the meet a friend interaction regimen is executed, the digital assistant may determine learned behavior associated with the meet a friend interaction. For example, the virtual assistant may know from past behavior that the user often forgets to bring an item when meeting Pam, who always has food ready. Based on this learned behavior, the virtual assistant determines virtual content data that codes for virtual content associated with the learned behavior in order to convey information to the user concerning the learned behavior. The virtual content data is used by the client system to generate and render virtual content in the extended reality environment 1200 displayed to the user. For example, the virtual assistant may place two temporary triggers 1250 on the handlebars of the bicycle 1210. A first of the triggers 1250 executes the workflow for the meeting up with the friend (e.g., Pam) straightaway; whereas a second trigger of the triggers 1250 makes a modification to the workflow for the meeting up with the friend (e.g., Pam) that adds a task to stop at the store along the way to meet the friend. The user may decide to go straight to the meeting with the friend and grabs the bike with her hand over the first trigger. Thereafter, the virtual assistant can guide the user meet-up with the friend in accordance with the tasks and virtual content data associated with the workflow (e.g., displaying a route to meet the friend). The virtual assistant continues to execute process 1200 (e.g., continuously, semi-continuously, or periodically) through-out execution of the meet a friend interaction to ensure the user remains engaged and is following the tasks defined for the workflow or to determine whether a new interaction is trigged by the context of the new data. Advantageously, the user's learned behavior can be used to modify interactions or recommend interactions, and the user's physical interactions with the environment can be leveraged as a responsive technique to filter down the user's intended goal.

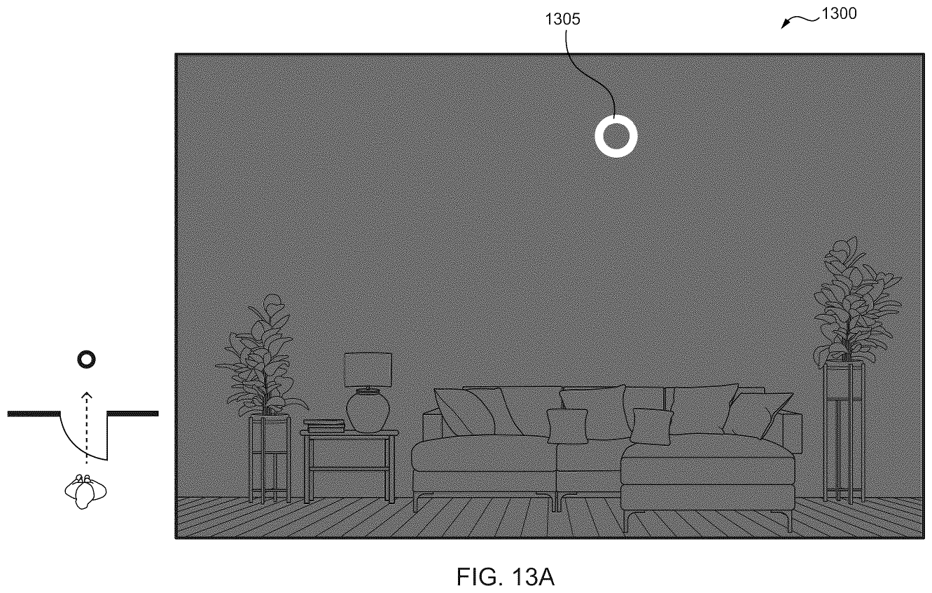

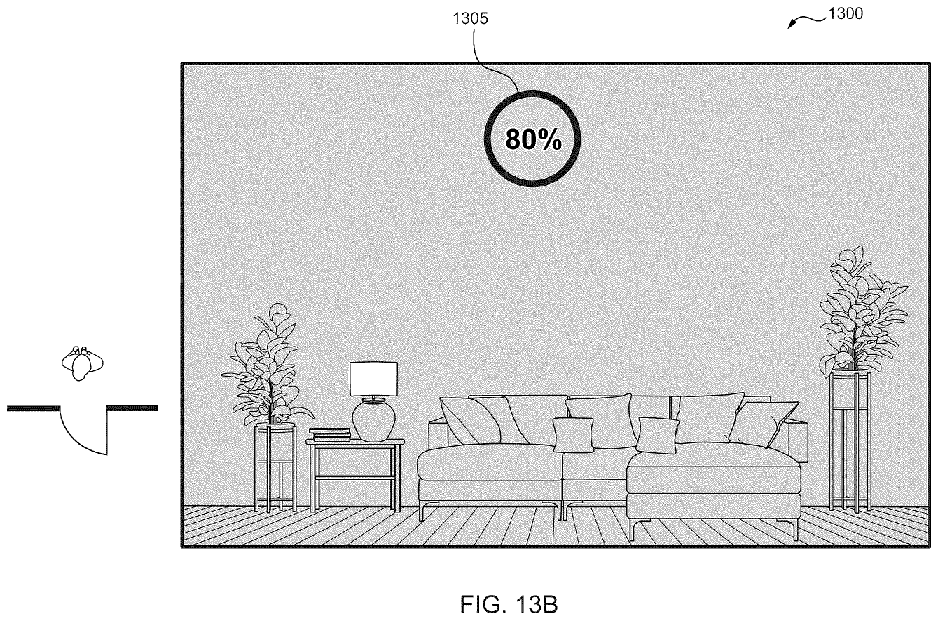

FIGS. 13A-13B illustrate presenting, initiating, and executing one or more interactions with learned behavior in an extended reality environment 1300 via the virtual content generated and rendered in process 1100. FIG. 13A shows that the virtual assistant has determined that, based on context of a user's present input data, an interaction: home mode—should be recommended to the user to achieve an immediate goal of turning the lights on, transition to home mode, and/or read a chapter before bed (which goes towards achieving an intermediate goal of finish reading a book and a long-term goal of cutting wasted time). The context in this particular instance is that the user enters the front door. In order to present this recommendation to the user, the virtual assistant determines that the home mode interaction has an action space that defines virtual content data for presenting the home mode interaction to the user. The virtual content data codes for virtual content such as a glimmer 1305 (e.g., a focal point) to be placed on a physical object such as a light, wall, or ceiling. The virtual content data is used by the client system to generate and render the glimmer 1305 in the extended reality environment 1300 displayed to the user. The purpose of the glimmer 1305 is to gain the attention of the user and signal that the virtual assistant has information (e.g., a preset function for the home mode interaction has been triggered and will complete in a few moments) to convey to the user.

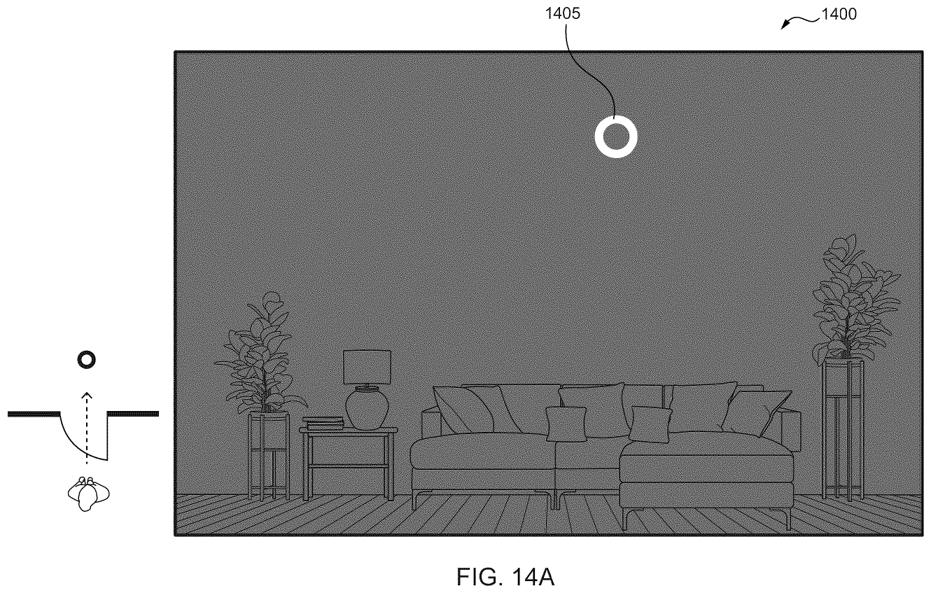

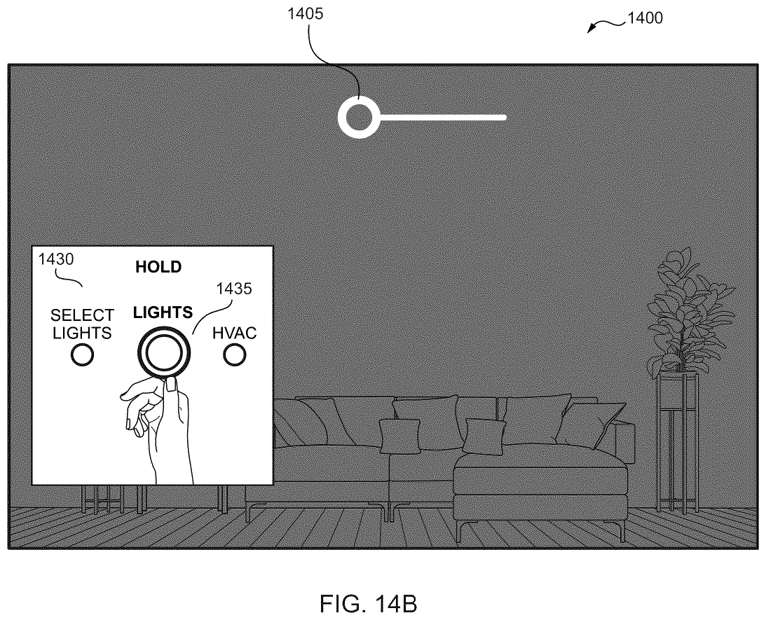

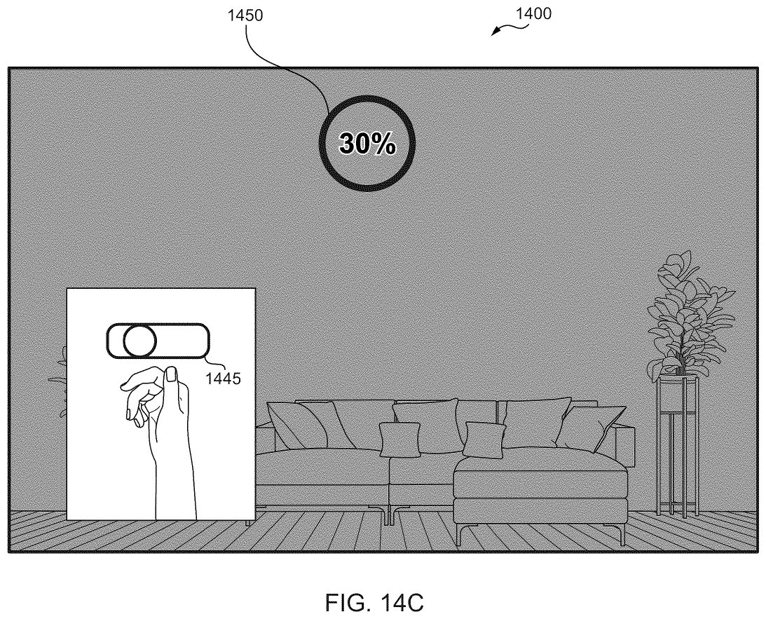

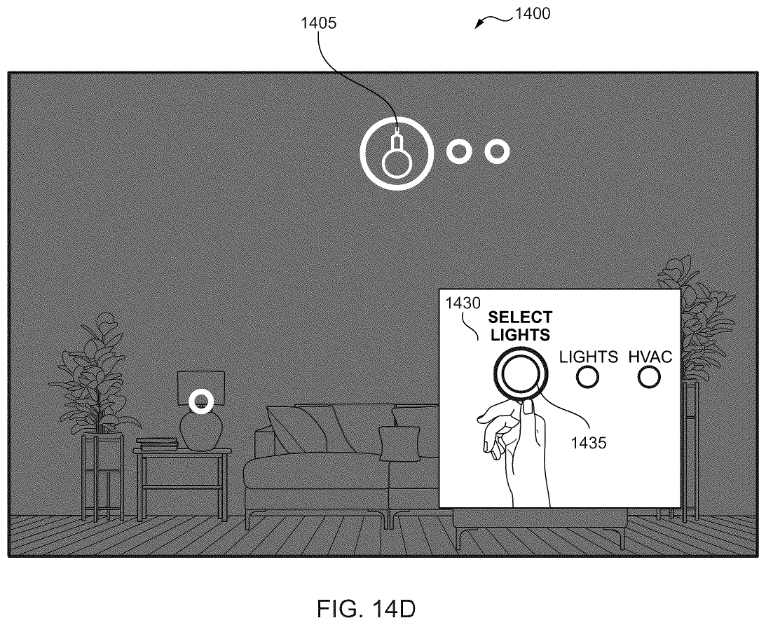

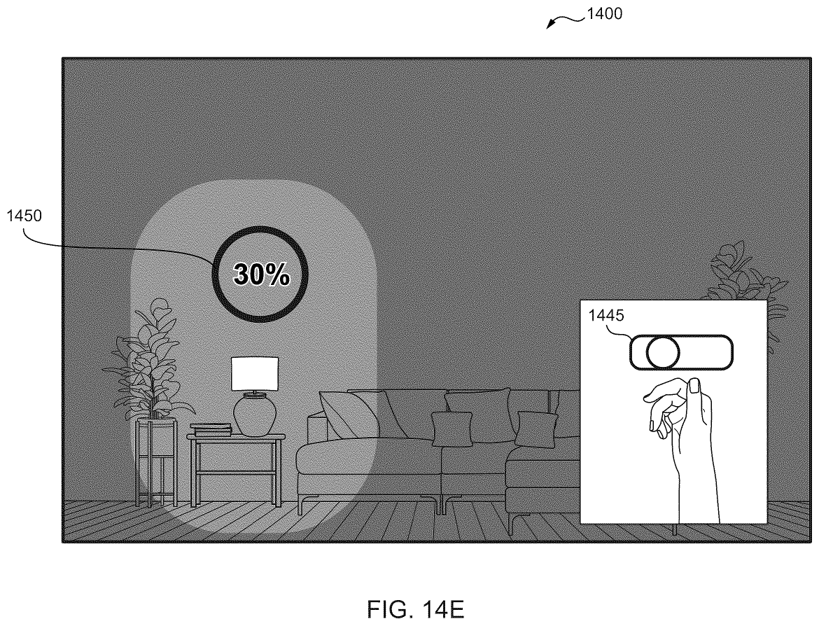

At this phase, the user can: ignore the initiation and execution of the preset function for the home mode interaction (e.g., convey disinterest in modifying the interaction) or execute a command to interrupt the initiation and execution of the preset function (e.g., convey interest in modifying the interaction). The virtual assistant receives new data and executes process 1100 based on the new data. If the graph determined by the virtual assistant for the new data does not include a request that the client system render a user interface to interact with the virtual assistant and communicate the modification, the virtual assistant determines the preset function can be initiated and executed as presently defined. For example, the user may be familiar with the preset function and settings thereof as this interaction is a daily occurrence. If the graph determined by the virtual assistant for the new data does include a request that the client system render a user interface to interact with the virtual assistant and communicate the modification, the virtual assistant interrupts the preset function and renders a user interface for the user as described in further detail with respect to FIGS. 14A-14E.

As shown in FIG. 13B, once the home mode interaction is initiated, the digital assistant may determine learned behavior, or a predefined setting associated with the home mode interaction. For example, the virtual assistant may know from past behavior or a predefined setting that the user likes the lights at this time of year and day to be set to 80% intensity when home and the thermostat at this time of year and day to be set to 70 degrees when home. Accordingly, as the user continues to take off their shoes and coat, based on this learned behavior or predefined settings, the virtual assistant continues to execute the preset function for the home mode interaction in order to turn on the lights and set them to 80% intensity and set the thermostat to 70 degrees.

FIGS. 14A-14E illustrate presenting, initiating, and executing one or more interactions with learned behavior in an extended reality environment 1400 via the virtual content generated and rendered in process 1100. FIG. 14A shows that the virtual assistant has determined that, based on context of a user's present input data, an interaction: home mode—should be recommended to the user to achieve an immediate goal of turning the lights on, transition to home mode, and/or read a chapter before bed (which goes towards achieving an intermediate goal of finish reading a book and a long-term goal of cutting wasted time). The context in this particular instance is that the user enters the front door. In order to present this recommendation to the user, the virtual assistant determines that the home mode interaction has an action space that defines virtual content data for presenting the home mode interaction to the user. The virtual content data codes for virtual content such as a glimmer 1405 (e.g., a focal point) to be placed on a physical object such as a light, wall, or ceiling. The virtual content data is used by the client system to generate and render the glimmer 1405 in the extended reality environment 1400 displayed to the user. The purpose of the glimmer 1405 is to gain the attention of the user and signal that the virtual assistant has information (e.g., a preset function for the home mode interaction has been triggered and will complete in a few moments) to convey to the user.

At this phase, the user can: ignore the initiation and execution of the preset function for the home mode interaction (e.g., convey disinterest in modifying the interaction) or execute a command to interrupt the initiation and execution of the preset function (e.g., convey interest in modifying the interaction). The virtual assistant receives new data and executes process 1100 based on the new data. If the graph determined by the virtual assistant for the new data does not include a request that the client system render a user interface to interact with the virtual assistant and communicate the modification, the virtual assistant determines the preset function can be initiated and executed as presently defined. If the graph determined by the virtual assistant for the new data does include a request that the client system render a user interface to interact with the virtual assistant and communicate the modification, the virtual assistant interrupts the preset function and renders a user interface for the user. For example, the user may be familiar with the preset function and settings thereof as this interaction is a daily occurrence. However, in this instance, the user wants to adjust the overall light intensity.

As further shown in FIG. 14B, at this phase, the user may decide to make a modification to the home mode interaction proposed by the virtual assistant. In some instances, the user may decide to make a modification to change a setting for the home mode interaction (the change can be only for this instance of execution of the home mode interaction or to be implemented for all instances of the execution of the home mode interaction going forward). For example, the user may decide that they would like the light to be less intense today, for whatever reason. In order to make the modification, the user can request that the client system render a user interface 1430 to interact with the virtual assistant and communicate the modification. As should be understood, the request for a modification to the setting for only this occurrence of the home mode interaction can be made at any time/phase, even prior to the presentation of the one or more interactions or after the execution of the one or more interactions (e.g., if the user simply wants to initiate an interaction with the virtual assistant).

In response to the request by the user for the user interface 1430, the client system generates and renders the user interface 1430 in the extended reality environment 1400 displayed to the user. The user interface 1430 visualizes information such as modification suggestions 1435 made by the virtual assistant based on available data (e.g., settings of home mode that can be modified). The user can use a gesture or combination of gestures to navigate through the user interface 1430 and view and/or select suggestions 1435.

As shown in FIGS. 14B and 14C, the virtual assistant receives interface input from the user interacting with the user interface. The virtual assistant determines one or more modifications to be made to the one or more interactions based on the interface input (e.g., change overall light intensity). In some instances, the user interaction may execute one or more modifications, e.g., automatically execute adjusting the lights, if the virtual assistant has a defined setting for light intensity. In some instances, the virtual assistant additionally or alternatively determines virtual content data to be used for generating virtual content based on one or more modifications (e.g., virtual content data associated with the interaction—lights). For example, the user may choose to start the light interaction, and if the virtual assistant does not have a defined setting for the light intensity or if the user wants to change the defined setting for the light intensity, the user is able to hold down the light button, and access another virtual interface 1445 (the virtual content data codes for virtual content such as another user interface generated based on the one or more modifications). The virtual content data is used by the client system to generate and render the virtual interface 1445 in the extended reality environment 1400 displayed to the user. Still holding the virtual interface 1445, the user is able to communicate interface input to the virtual assistant by a gesture (e.g., sliding) with the virtual interface 1445 to adjust the light intensity 1450 accordingly.

Alternatively, as shown in FIG. 14D, at this phase, the user may decide to make a modification to the home mode interaction proposed by the virtual assistant. In some instances, the user may decide to make a modification to change a component for the home mode interaction (the change can be only for this instance of execution of the home mode interaction or to be implemented for all instances of the execution of the home mode interaction going forward). For example, the user may decide that they would like only a particular light to be turned on today, for whatever reason. In order to make the modification, the user can request that the client system render a user interface 1430 to interact with the virtual assistant and communicate the modification. As should be understood, the request for a modification to the setting for only this occurrence of the home mode interaction can be made at any time/phase, even prior to the presentation of the one or more interactions or after the execution of the one or more interactions (e.g., if the user simply wants to initiate an interaction with the virtual assistant).

In response to the request by the user for the user interface 1430, the client system generates and renders the user interface 1430 in the extended reality environment 1400 displayed to the user. The user interface 1430 visualizes information such as modification suggestions 1435 made by the virtual assistant based on available data (e.g., components of home mode that can be modified). The user can use a gesture or combination of gestures to navigate through the user interface 1430 and view and/or select suggestions 1435.

As shown in FIGS. 14D and 14E, the virtual assistant receives interface input from the user interacting with the user interface. The virtual assistant determines one or more modifications to be made to the one or more interactions based on the interface input (e.g., selection of lights). In some instances, the user interaction may execute one or more modifications, e.g., automatically turn on the selected light, if the virtual assistant has a defined setting for the light. In some instances, the virtual assistant additionally or alternatively determines virtual content data to be used for generating virtual content based on one or more modifications (e.g., virtual content data associated with the interaction—lights). For example, the user may choose to start the light interaction, and if the virtual assistant does not have a defined setting for the light intensity or if the user wants to change the defined setting for the light intensity, the user is able to hold down the light button and access another virtual interface 1445 (the virtual content data codes for virtual content such as another user interface generated based on the one or more modifications). The virtual content data is used by the client system to generate and render the virtual interface 1445 in the extended reality environment 1400 displayed to the user. Still holding the virtual interface 1445, the user is able to communicate interface input to the virtual assistant by a gesture (e.g., sliding) with the virtual interface 1445 to adjust the light intensity 1450 accordingly.

### Additional Considerations

Although specific examples have been described, various modifications, alterations, alternative constructions, and equivalents are possible. Examples are not restricted to operation within certain specific data processing environments but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

1-20. (canceled)

21. A method, comprising:
in accordance with a determination that an image captured by an augmented-reality headset includes a real-world object that is associated with a user goal:
causing output, via the augmented-reality headset, of a virtual indicator near the real-world object;
in accordance with a first user interaction with the virtual indicator or the real-world object satisfying an interaction criteria:
causing output, via the augmented-reality headset and based on the first user interaction and the user goal associated with the real-world object, of first content that is associated with the user goal;
in accordance with a second user interaction with the first content, capturing an image of a user wearing the augmented-reality headset; and
in accordance with a determination that the image of the user and the first content meets similarity criteria:
causing output, via the augmented-reality headset, of a second content associated with the user goal that is distinct from the first content.

22. The method of claim 21, wherein the virtual indicator is a glimmer that indicates an available interaction at the virtual indicator.

23. The method of claim 21, wherein the first user interaction with the virtual indicator is an eye gaze at the virtual indicator.

24. The method of claim 21, further comprising, in accordance with a determination that the image of the user and the first content does not meet similarity criteria, ceasing to display the first content that is associated with the user goal.

25. The method of claim 21, wherein:
the first content includes display of an example exercise pose; and
the similarity criteria is based on a pose of the user of the second user interaction and the example exercise pose.

26. The method of claim 25, wherein a complexity or intensity of the example exercise pose is based on previous user interactions associated with the user goal by the user.

27. The method of claim 21, wherein:
the virtual indicator is output based on a time or time interval associated with the user goal so that the user has sufficient time to complete the user goal;
the first content includes a representation of the time or time interval associated with the user goal; and
the second content includes a representation of a list of tasks associated with the user goal.

28. The method of claim 21, further comprising:
in accordance with a third user interaction with the second content:
causing output, via the augmented-reality headset and based on the second user interaction and the user goal associated with the real-world object, of a third content that is associated with the user goal that is distinct from the first content and the second content.

29. The method of claim 21, further comprising:
in accordance with a fourth user interaction with a virtual assistant:
causing output, via the augmented-reality headset, of a user interface for the virtual assistant concurrent with the first content or the second content; and
in accordance with a fifth user interaction with the user interface for the virtual assistant:
determining one or more modifications to be made to the first content or the second content based on the fifth user interaction with the user interface for the virtual assistant; and
causing output, via the augmented-reality headset, of a modified first content or a modified second content.

30. An augmented-reality headset, comprising:
display configured to display content to a user;
one or more sensors to capture input data; and
one or more processors configured to:
in accordance with a determination that an image captured by an augmented-reality headset includes a real-world object that is associated with a user goal:
cause output, via the augmented-reality headset, of a virtual indicator near the real-world object;
in accordance with a first user interaction with the virtual indicator or the real-world object satisfying an interaction criteria:
cause output, via the augmented-reality headset and based on the first user interaction and the user goal associated with the real-world object, of first content that is associated with the user goal;
in accordance with a second user interaction with the first content, capture an image of a user; and
in accordance with a determination that the image of the user and the first content meets similarity criteria:
cause output, via the augmented-reality headset, of a second content associated with the user goal that is distinct from the first content.

31. The augmented-reality headset of claim 30, wherein:
the virtual indicator is a glimmer that indicates an available interaction at the virtual indicator; and
the first user interaction with the virtual indicator is an eye gaze at the virtual indicator.

32. The augmented-reality headset of claim 30, wherein:
the first content includes display of an example exercise pose; and
the similarity criteria is based on a pose of the user of the second user interaction and the example exercise pose.

33. The augmented-reality headset of claim 32, wherein a complexity or intensity of the example exercise pose is based on previous user interactions associated with the user goal by the user.

34. The augmented-reality headset of claim 30, wherein:
the virtual indicator is output based on a time or time interval associated with the user goal so that the user has sufficient time to complete the user goal;
the first content includes a representation of the time or time interval associated with the user goal; and
the second content includes a representation of a list of tasks associated with the user goal.

35. The augmented-reality headset of claim 30, wherein the one or more processors are further configured to:
in accordance with a third user interaction with the second content:
cause output, via the augmented-reality headset and based on the second user interaction and the user goal associated with the real-world object, of a third content that is associated with the user goal that is distinct from the first content and the second content; and
in accordance with a fourth user interaction with a virtual assistant:
cause output, via the augmented-reality headset, of a user interface for the virtual assistant concurrent with the first content or the second content; and
in accordance with a fifth user interaction with the user interface for the virtual assistant:
determine one or more modifications to be made to the first content or the second content based on the fifth user interaction with the user interface for the virtual assistant; and
cause output, via the augmented-reality headset, of a modified first content or a modified second content.

36. A non-transitory computer-readable medium storing instructions that, when executed by one or more processors of an augmented-reality headset, cause the one or more processors to:
in accordance with a determination that an image captured by an augmented-reality headset includes a real-world object that is associated with a user goal:
cause output, via the augmented-reality headset, of a virtual indicator near the real-world object;
in accordance with a first user interaction with the virtual indicator or the real-world object satisfying an interaction criteria:
cause output, via the augmented-reality headset and based on the first user interaction and the user goal associated with the real-world object, of first content that is associated with the user goal;
in accordance with a second user interaction with the first content, capture an image of a user; and
in accordance with a determination that the image of the user and the first content meets similarity criteria:
cause output, via the augmented-reality headset, of a second content associated with the user goal that is distinct from the first content.

37. The non-transitory computer-readable medium of claim 36, wherein:
the virtual indicator is a glimmer that indicates an available interaction at the virtual indicator; and
the first user interaction with the virtual indicator is an eye gaze at the virtual indicator.

38. The non-transitory computer-readable medium of claim 36, wherein:
the first content includes display of an example exercise pose; and
the similarity criteria is based on a pose of the user of the second user interaction and the example exercise pose.

39. The non-transitory computer-readable medium of claim 36, wherein:
the virtual indicator is output based on a time or time interval associated with the user goal so that the user has sufficient time to complete the user goal;
the first content includes a representation of the time or time interval associated with the user goal; and
the second content includes a representation of a list of tasks associated with the user goal.

40. The non-transitory computer-readable medium of claim 36, wherein the instructions, when executed by the one or more processors of the augmented-reality headset, further cause the one or more processors to:
in accordance with a third user interaction with the second content:
cause output, via the augmented-reality headset and based on the second user interaction and the user goal associated with the real-world object, of a third content that is associated with the user goal that is distinct from the first content and the second content; and
in accordance with a fourth user interaction with a virtual assistant:
cause output, via the augmented-reality headset, of a user interface for the virtual assistant concurrent with the first content or the second content; and
in accordance with a fifth user interaction with the user interface for the virtual assistant:
determine one or more modifications to be made to the first content or the second content based on the fifth user interaction with the user interface for the virtual assistant; and
cause output, via the augmented-reality headset, of a modified first content or a modified second content.
